(19) United States
(12) Patent Application Publication
(10) Pub. No.: US 2013/0171601 A1
(43) Pub. Date: Jul. 4, 2013

(54) EXERCISE ASSISTING SYSTEM

(71) Applicants: Shingo Yuasa, Osaka (JP); Hiroyuki Saito, Osaka (JP); Chiaki Yoshizuka, Kyoto (JP)

(72) Inventors: Shingo Yuasa, Osaka (JP); Hiroyuki Saito, Osaka (JP); Chiaki Yoshizuka, Kyoto (JP)

(73) Assignee: PANASONIC CORPORATION, Osaka (JP)

(21) Appl. No.: 13/822,828

(22) PCT Filed: Sep. 22, 2011
(86) PCT No.: PCT/JP2011/071667

§ 371 Date: Mar. 13, 2013

(30) Foreign Application Priority Data
Sep. 22, 2010 (JP) 2010-212732
Sep. 22, 2010 (JP) 2010-212733
Sep. 27, 2010 (JP) 2010-216221

(51) Int. Cl. G09B 19/00

(52) U.S. Cl. CPC G09B 19/00
USPC 434/258

(57) ABSTRACT

The exercise assisting system includes: a display device including a display screen displaying an image to a user; a comparison image storing unit storing a comparison image representing an image of an exerciser performing a predetermined exercise; a comparison image display unit displaying the comparison image stored in the storing unit on the screen; a mirror image displaying means displaying a mirror image of the user so as to overlap the comparison image; a characteristic amount extraction unit detecting positions of sampling points of a body of the user and calculating a characteristic amount representing a posture of the user based on the position; a posture estimation unit comparing the characteristic amount from the extraction unit with a criterion amount representing a posture of the exerciser and estimating a deviation between postures of the user and the exerciser; and a presentation unit presenting an estimation result of the estimation unit.

### TECHNICAL FIELD

The present invention relates to an exercise assisting system for assisting an exercise of a user.

### BACKGROUND ART

For example, in a field of rehabilitation, generally, patients who have a problem with its four limbs due to a disease or injury perform a predetermined exercise in order to recover functions of their four limbs. However, the patients cannot understand how to move their bodies unless a posture as a model is not presented, and they cannot perform a proper exercise. Hence, there is possibility that they cannot obtain sufficient effects of rehabilitation.

In view of the above, when the patient performs an exercise by oneself, the patient generally displays a picture representing a model posture recorded on a DVD or a videotape on a monitor and moves one's body in accordance with the displayed picture (see document 1 “JP 9-56697 A”).

Further, as for a healthy person, in an exercise such as yoga and a dance, displaying a picture representing a model posture on a monitor and moving one's body in accordance with the displayed picture is common.

However, when only the model picture is displayed on the monitor, the patient cannot judge whether or not the patient can move its body appropriately, and cannot understand how different the one's posture is from the posture in the picture displayed on the monitor. Therefore, even when the posture of the patient is greatly deviated from the picture displayed, the patient cannot recognize such a great deviation by oneself, but continues the exercise without voluntarily correcting one's posture. As a result, the patient may not obtain a sufficient effect of the exercise.

### SUMMARY OF INVENTION

In view of the above insufficiency, the present invention has aimed to propose an exercise assisting system capable of enabling a user to visually recognize a posture of the user and of enabling the user to recognize how much different between the posture of the user and a posture in a displayed picture.

The first aspect of the exercise assisting system in accordance with the present invention includes: a display device including a display screen for displaying an image to a user; a comparison image storage unit configured to store a comparison image defined as an image of an exerciser performing a predetermined exercise; a comparison image display unit configured to display the comparison image stored in the comparison image storage unit on the display screen; a mirror image displaying means configured to display a mirror image of the user such that the mirror image is superimposed onto the comparison image; a characteristic amount extraction unit configured to detect a position of predetermined one or more sampling points of a body of the user and calculate a characteristic amount representing a posture of the user based on the position of the one or more sampling points; a posture estimation unit configured to compare the characteristic amount calculated by the characteristic amount extraction unit with a criterion amount representing a posture of the exerciser and perform estimation of a deviation between the posture of the user and the posture of the exerciser; and a presentation unit configured to give a result of the estimation performed by the posture estimation unit.

As for the second aspect of the exercise assisting system in accordance with the present invention, in addition to the first aspect, the mirror image displaying means is a half mirror placed in front of the display device.

As for the third aspect of the exercise assisting system in accordance with the present invention, in addition to the first aspect, the mirror image displaying means includes: an image pickup device configured to shoot the user to create an image of the user; an inverse processing unit configured to reverse the image of the user created by the image pickup device from left to right and create a mirror-reversed image; and an inverted image display unit configured to display the mirror-reversed image created by the inverse processing unit.

As for the fourth aspect of the exercise assisting system in accordance with the present invention, in addition to any one of the first to third aspects, the predetermined exercise is a model of an exercise performed by the user.

As for the fifth aspect of the exercise assisting system in accordance with the present invention, in addition to any one of the first to third aspects, the exercise assisting system further includes: an image pickup device configured to shoot the user performing the predetermined exercise and create a recorded image defined as an image of the user performing the predetermined exercise; and a criterion amount extraction unit. The comparison image display unit is configured to display, on the display screen, the recorded image created by the image pickup device as the comparison image. The criterion amount extraction unit is configured to detect the position of the predetermined one or more sampling points of the body of the user from the recorded image and calculate the characteristic amount representing the posture of the user based on the position of the one or more sampling points, as the criterion amount.

As for the sixth aspect of the exercise assisting system in accordance with the present invention, in addition to any one of the first to fifth aspects, the characteristic amount extraction unit is configured to detect the positions of the respective plural sampling points of the body of the user and create a human body model representing the body of the user based on the positions of the respective plural sampling points and calculate the characteristic amount based on the human body model.

As for the seventh aspect of the exercise assisting system in accordance with the present invention, in addition to the sixth aspect, the characteristic amount is defined as an angle between a predetermined criterion line and a straight line connecting the two sampling points selected from the plural sampling points.

As for the eighth aspect of the exercise assisting system in accordance with the present invention, in addition to any one of the first to fifth aspects, the characteristic amount is defined as an inclination of the body of the user.

As for the ninth aspect of the exercise assisting system in accordance with the present invention, in addition to the eighth aspect, the inclination of the body of the user is defined as an inclination of a shoulder of the user. The characteristic amount extraction unit is configured to detect the positions of the sampling points of right and left upper limbs of the user, and calculate an angle between a horizontal line and a straight line connecting the sampling points of the right and left upper limbs, as the inclination of the shoulder of the user.

As for the tenth aspect of the exercise assisting system in accordance with the present invention, in addition to the eighth aspect, the inclination of the body of the user is defined as an inclination of a body trunk of the user. The characteristic amount extraction unit is configured to detect the positions of the sampling points of a head and a lower back of the user, and calculate an angle between a vertical line and a straight line connecting the sampling points of the head and the lower back, as the inclination of the body trunk of the user.

As for the eleventh aspect of the exercise assisting system in accordance with the present invention, in addition to any one of the first to fifth aspects, the characteristic amount represents a range of motion of a certain portion of the body of the user.

As for the twelfth aspect of the exercise assisting system in accordance with the present invention, in addition to the eleventh aspect, the certain portion is an upper limb of the user. The characteristic amount extraction unit is configured to detect the positions of the sampling points of the upper limb and a shoulder connected to the upper limb of the user and calculate an angle between a vertical line and a straight line connecting the sampling points of the upper limb and the shoulder as the range of motion of the upper limb.

As for the thirteenth aspect of the exercise assisting system in accordance with the present invention, in addition to the sixth aspect, the number of the sampling points is three or more. The characteristic amount is an area of a closed region defined by the sampling points.

As for the fourteenth aspect of the exercise assisting system in accordance with the present invention, in addition to any one of the first to thirteenth aspects, the comparison image display unit is configured to adjust at least one of a position and a size of the comparison image on the display screen such that the comparison image is superimposed on the mirror image of the user.

As for the fifteenth aspect of the exercise assisting system in accordance with the present invention, in addition to the first aspect, the posture estimation unit is configured to calculate a numerical value indicative of a difference between the characteristic amount and the criterion amount. The presentation unit is configured to present the numerical value calculated by the posture estimation unit.

As for the sixteenth aspect of the exercise assisting system in accordance with the present invention, in addition to the first aspect, the exercise assisting system further includes: a position detection unit configured to measure a position of a certain portion of the body of the user; a marker setting unit configured to decide a position of a marker on the display screen based on the position measured by the position detection unit; a judgment unit configured to judge whether or not the marker is in a predetermined position on the display screen; an event image display unit configured to, when the judgment unit determines that the marker is in the predetermined position, display a predetermined event image at the predetermined position; an estimation data generation unit configured to create estimation data indicative of a range of motion of the certain portion based on the position measured by the position detection unit; and a range-of-motion estimation unit configured to make estimation of the range of motion of the certain portion based on a comparison of the estimation data created by the estimation data generation unit with criterion data. The presentation unit is configured to present a result of the estimation made by the range-of-motion estimation unit.

As for the seventeenth aspect of the exercise assisting system in accordance with the present invention, in addition to the sixteenth aspect, the range-of-motion estimation unit is configured to adopt the estimation data used in the previous estimation of the range of motion of the certain portion as the criterion data.

As for the eighteenth aspect of the exercise assisting system in accordance with the present invention, in addition to the sixth aspect, the criterion data is defined as data indicative of a standard range of motion of the certain portion of a healthy person.

As for the nineteenth aspect of the exercise assisting system in accordance with the present invention, in addition to any one of the sixteenth to eighteenth aspects, the estimation data includes data indicative of an area of a region through which the certain portion has passed within a plane parallel to the display screen.

As for the twentieth aspect of the exercise assisting system in accordance with the present invention, in addition to any one of the sixteenth to nineteenth aspects, the estimation data includes data indicative of a range of motion of the certain portion in a predetermined direction.

As for the twenty-first aspect of the exercise assisting system in accordance with the present invention, in addition to any one of the sixteenth to twentieth aspects, the estimation data includes data indicative of time necessary for the user to make a predetermined motion with the certain portion.

As for the twenty-second aspect of the exercise assisting system in accordance with the present invention, in addition to any one of the sixteenth to twenty-first aspects, the position detection unit is configured to measure a position of the certain portion based on an output of a three-dimensional sensor. The estimation data includes data indicative of a volume of a space through which the certain portion has passed.

As for the twenty-third aspect of the exercise assisting system in accordance with the present invention, in addition to any one of the sixteenth to twenty-second aspects, the estimation data includes data indicative of tracks of the certain portion.

As for the twenty-fourth aspect of the exercise assisting system in accordance with the present invention, in addition to any one of the sixteenth to twenty-third aspects, the mirror image displaying means is defined as a half mirror positioned in front of the display device. The marker setting unit is configured to decide the position of the marker such that the position of the marker is corresponding to a position in the display screen overlapping the certain portion in the half mirror.

As for the twenty-fifth aspect of the exercise assisting system in accordance with the present invention, in addition to any one of the sixteenth to twenty-third aspects, the mirror image displaying means includes: an image pickup device configured to shoot the user and create an image of the user; an inverse processing unit configured to reverse the image of the user created by the image pickup device from left to right and create a mirror-reversed image; and an inverted image display unit configured to display the mirror-reversed image created by the inverse processing unit. The marker setting unit is configured to decide the position of the marker such that the position of the marker is corresponding to the position of the certain portion in the mirror-reversed image.

As for the twenty-sixth aspect of the exercise assisting system in accordance with the present invention, in addition to the first aspect, the exercise assisting system further includes: a measurement device having a working surface for receiving a load from the user and configured to measure a distribution of the load in the working surface; a calculation unit configured to calculate a balance value representing a proportion of the load at a prescribed position in the working surface based on the distribution of the load measured by the measurement device; a balance value storage unit configured to store the balance value calculated by the calculation unit; a balance value display unit configured to display the balance value calculated by the calculation unit on the display screen; a setting data storage unit configured to store setting data indicative of a time variation of a target value for the balance value; a target value display unit configured to display the target value on the display screen based on the setting data stored in the setting data storage unit; and a center of gravity shifting estimation unit configured to calculate a time variation of the balance value from the balance value stored in the balance value storage unit and make estimation of a center of gravity shifting of the user based on the time variation of the balance value and the time variation of the target value indicated by the setting data. The presentation unit is configured to present a result of the estimation made by the center of gravity shifting estimation unit.

As for the twenty-seventh aspect of the exercise assisting system in accordance with the present invention, in addition to the twenty-sixth aspect, the center of gravity shifting estimation unit is configured to make the estimation of the center of gravity shifting by use of a difference between the balance value and the target value at a predetermined time point.

As for the twenty-eighth aspect of the exercise assisting system in accordance with the present invention, in addition to the twenty-sixth aspect or the twenty-seventh aspect, the exercise assisting system further comprises a setting update unit configured to modify the time variation of the target value indicated by the setting data stored in the setting data storage unit in accordance with the result of the estimation made by the center of gravity shifting estimation unit.

As for the twenty-ninth aspect of the exercise assisting system in accordance with the present invention, in addition to any one of the twenty-sixth to twenty-eighth aspects, the mirror image display unit is defined as an half mirror placed in front of the display screen.

### BRIEF DESCRIPTION OF DRAWINGS

FIG. 1 is a schematic diagram illustrating a system configuration of the exercise assisting system of the first embodiment;

FIG. 2 is an explanatory view illustrating an operation of the exercise assisting system of the above first embodiment;

FIG. 3 is an explanatory view illustrating a process of creating a human body model used in the exercise assisting system of the above first embodiment;

FIG. 4 is an explanatory view illustrating a process of creating a human body model used in the exercise assisting system of the above first embodiment;

FIG. 5 is an explanatory view illustrating a deviation of a posture of the human body model used in the exercise assisting system of the above first embodiment;

FIG. 6 is an explanatory view illustrating the deviation of the posture of the human body model used in the exercise assisting system of the above first embodiment;

FIG. 7 is an explanatory view illustrating a process of calculating an inclination of a shoulder in the exercise assisting system of the above first embodiment;

FIG. 8 is an explanatory view illustrating a process of calculating an inclination of a body trunk in the exercise assisting system of the above first embodiment;

FIG. 9 is an explanatory view illustrating a process of calculating a range of motion of an upper limb in the exercise assisting system of the above first embodiment;

FIG. 10 is a schematic diagram illustrating a system configuration of the exercise assisting system of the second embodiment;

FIG. 11 is a schematic diagram illustrating a system configuration of the exercise assisting system of the third embodiment;

FIG. 12 is a block diagram illustrating an image creating unit of the exercise assisting system of the above third embodiment;

FIG. 13 is an explanatory view illustrating a display example of the display device of the exercise assisting system of the above third embodiment;

FIG. 14 is an explanatory view illustrating a display example of the display device of the exercise assisting system of the above third embodiment;

FIG. 15 is an explanatory view illustrating a display example of the display device of the exercise assisting system of the above third embodiment;

FIG. 16 is a block diagram illustrating a control device of the exercise assisting system of the fourth embodiment;

FIG. 17 is a schematic diagram illustrating a system configuration of the exercise assisting system of the fifth embodiment;

FIG. 18 is a block diagram illustrating the control device of the exercise assisting system of the above fifth embodiment;

FIG. 19 is an explanatory view illustrating a display example of the display device of the exercise assisting system of the above fifth embodiment; and

FIG. 20 is a block diagram illustrating the control device of the exercise assisting system of the above sixth embodiment.

### DESCRIPTION OF EMBODIMENTS

### First Embodiment

The exercise assisting system 1 of the present embodiment is used for rehabilitation aimed to make a patient suffering from faults of four limbs due to illness or injury perform a predetermined exercise in order to recover functions of the four limbs. The following embodiments are not made to limit applications of the exercise assisting system. For example, the exercise assisting system can be used for an exercise (e.g., yoga and dances) performed by a healthy person. In the following explanations, a user uses the exercise assisting system with standing. However, a user may use the exercise assisting system with sitting on a chair, for example.

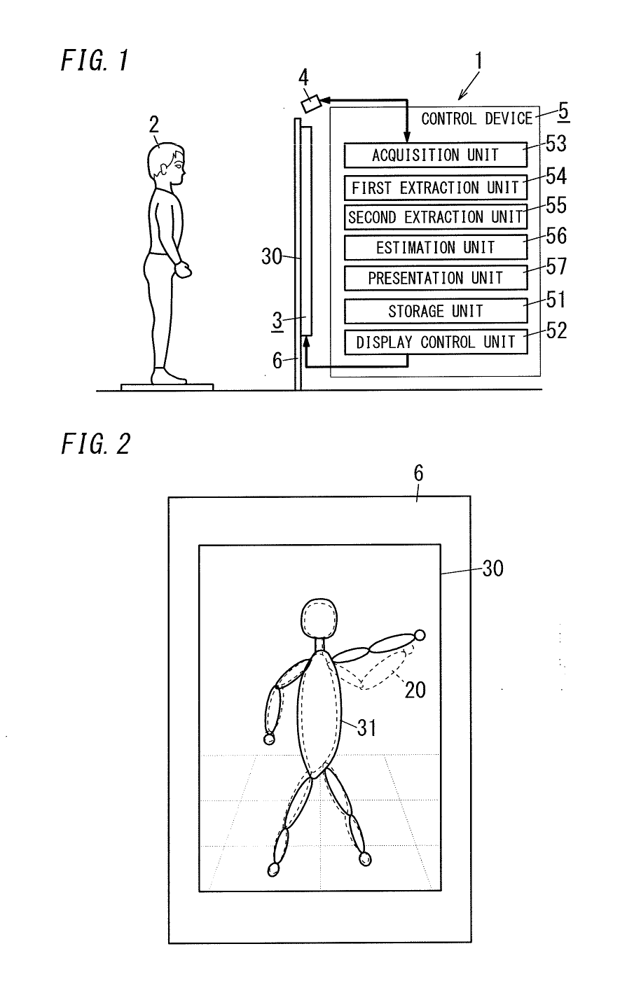

As shown in FIG. 1, the exercise assisting system 1 of the present embodiment includes a display device 3, a distance image sensor 4, and a control device 5. The display device 3 is configured to display an image on a display screen 30 placed in front of a user (patient) 2 so as to face the user 2. The distance image sensor 4 is configured to create a distance image. The control device 5 is configured to control operations of the display device 3 and the like. Each of the display device 3 and the distance image sensor 4 is connected to the control device 5.

Further, the exercise assisting system 1 includes a half mirror 6 placed on a front side (user 2 side) of the display screen 30 of the display device 3. The half mirror 6 is placed perpendicularly between the display device 3 and the user 2 such that a front face (mirror surface) of the half mirror 6 faces the user 2. The half mirror 6 is designed to allow the user 2 to see an image displayed by the display device 3 behind the half mirror 6.

The display device 3 includes the display screen 30 for displaying an image to the user 2. In this embodiment, the display device 3 is a plasma display. The display device 3 is attached to a rear side of the half mirror 6. In FIG. 1, a structure for supporting the half mirror 6 and an attachment structure of the display device 3 are not shown. However, the half mirror 6 and the display device 3 are successfully placed in predetermined positions by use of appropriate structures. The display device 3 is not limited to a plasma display, but may be another display such as a liquid crystal display. Besides, it is considered to use, as an alternative to such a display, a display device which is constituted by a diffusion sheet (not shown) attached to a rear surface of the half mirror 6 and a projector (not shown) for projecting an image on the diffusion sheet from a rear side of the half mirror 6.

In the present embodiment, the half mirror 6 has a front face shaped into a vertically long rectangle. The half mirror 6 is designed to serve as a full-length mirror to reflect an entire body of the user 2. The half mirror 6 has a transmittance selected to serve as a mirror and allow the user 2 to see an image displayed by the display device 3 through the half mirror 6. The half mirror 6 is fabricated by means of subjecting at least one of opposite surfaces of a transparent substrate made of glass or synthetic resin to mirror coating by use of a metal film, for example.

In this embodiment, the display device 3 is placed such that the display screen 30 is in contact with the rear surface of the half mirror 6. The height (vertical) position of the display device 3 is selected such that a lower edge of the display device 3 is positioned higher than a lower end of the half mirror 6 by a predetermined distance and an upper edge of the display device 3 is positioned lower than an upper end of the half mirror 6 by a predetermined distance. Further, the center of the display device 3 is positioned higher than the center of the half mirror 6 by some degree. Moreover, to display an image displayed by the display device 3 on the front face of the half mirror 6 with high brightness, a transparent material used for adjustment of a refractive index to prevent reflection may be interposed between the half mirror 6 and the display screen 30.

According to the above configuration, the half mirror 6 functions to show the mirror image of the user 2 on the front face thereof in a similar manner as a mirror, and functions to show the image displayed on the display screen 30 of the display device 3 on the front face thereof. That is, when the user 2 is in front of the half mirror 6, the mirror image of the user 2 is reflected on the front face of the half mirror 6, as well as the picture displayed on the display device 3 passes through the half mirror 6 to be reflected on the front face of the half mirror 6. Although details will be described later, the picture displayed on the display device 3 is produced by the control device 5.

The distance image sensor 4 is configured to generate the distance image having pixels indicative of distance values from the intensity-modulated light by use of the time-of-flight method. However, it is sufficient that the distance image sensor 4 is configured to generate the distance image. Thus, the distance image sensor 4 is not limited to a distance image sensor based on the time-of-flight method. The distance image sensor 4 measures a distance to a detection object within a sensing area and produces the distance image showing a position of the detection object in the three-dimensional space.

In this embodiment, the distance image sensor 4 is placed over the display device 3 so as not to be overlapped with the display device 3. The distance image sensor 4 generates the distance image relating to the user 2 in front of the half mirror 6. The distance image sensor 4 is positioned over the display device 3 and substantially centered in the left and right direction. The distance image sensor 4 has an upwards or downwards pivoting direction (a tilt angle) which is selected such that the distance image sensor 4 looks down the user 2 from a location obliquely upward and forward from the user 2.

Further, the distance image sensor 4 has a left or right pivoting direction (a pan angle) adjusted such that the entire body of the user 2 is in a field of view of the distance image sensor 4 and such that a center line in the left and right direction of the distance image coincides with a center line in the left and right direction of the body of the user 2 having a standing posture.

Besides, the distance image sensor 4 is installed at a height position of the eyes of the user 2 on the front side (the user 2 side) of the half mirror 6 by utilizing, for example, a camera stand, etc.

The above described adjustment of the position and orientation of the distance image sensor 4 is performed as the initial setting after the position and the posture of the user 2 are determined. As a result of this, the distance image sensor 4 can generate a dynamic image constituted by the distance images reflecting the whole body of the user 2.

With regard to the exercise assisting system 1 of the present embodiment, the control device 5 includes a storage unit 51 and a display control unit 52. The storage unit 51 stores a comparison picture defined as a picture of a comparison object performing the same exercise as that performed by the user 2. The display control unit 52 is configured to control the display device 3 in such a manner to display the comparison picture while the user 2 exercises. In other words, the exercise assisting system 1 of the present embodiment includes a comparison image storage unit (storage unit) 51 and a comparison image display unit (display control unit) 52. The comparison image storage unit 51 is configured to store a comparison image (comparison picture) defined as an image of an exerciser performing a predetermined exercise. The comparison image display unit 52 is configured to display the comparison image stored in the comparison image storage unit 51 on the display screen 30.

In the present embodiment, the comparison picture is a picture of the comparison object showing a model of the exercise performed by the user 2. In other words, the predetermined exercise is the model of the exercise performed by the user 2. For example, the comparison picture is a dynamic image obtained by means of taking an image of an instructor as the comparison object performing the exercise performed by the user 2 by use of an image pickup device (not shown) placed in front of the instructor such that an entire body of the instructor is included in a field of view of the image pickup device. The comparison picture obtained by the above method is preliminarily stored in the storage unit 51. Besides, in the present embodiment, the comparison image may be a still image. In this situation, the comparison image shows a posture of the exerciser which should be viewed as a model of the user 2. In brief, the comparison image may be a still image of the exerciser performing the predetermined exercise or a dynamic image of the exerciser performing the predetermined exercise.

The display control unit 52 includes a size adjustment unit (not shown) and a position adjustment unit (not shown). The size adjustment unit is configured to adjust a size of the comparison picture on the display screen such that the user 2 can recognize that the mirror image of the user 2 reflected on the half mirror 6 is overlapped with the comparison object in the comparison picture. The position adjustment unit is configured to adjust a position of the comparison picture. In other words, the display control unit (comparison image display unit) 52 is configured to adjust at least one of the position and the size of the comparison image on the display screen 30 such that the comparison image is superimposed on the mirror image of the user 2.

When viewed from the point of view of the user 2, the mirror image reflected on the half mirror has half the actual size of the user 2. The size adjustment unit adjusts a display size of the comparison object such that the comparison object in the comparison picture displayed on the display screen 30 of the display device 3 has half the actual size of the comparison object. Besides, when the comparison object (instructor) and the user 2 have different physical constitutions (mainly, height), the size adjustment unit adjusts the display size such that the comparison object has the size identical to the size of the mirror image of the user 2. Even when the comparison object of the comparison picture does not have half its actual size but have the size greater or less than its actual size, there is no problem in the sense that the comparison image shows the model or example of the motion of the user 2.

The position adjustment unit has a positioning function of freely adjusting a display position of the comparison picture on the display screen 30. The position adjustment unit adjusts the display position of the display picture such that the comparison picture is displayed at a position in which the image of the comparison object (instructor) is superimposed on the mirror image of the user when viewed from the point of view of the user 2. For example, the position of the comparison picture on the display screen 30 is adjusted depending on the position relation between the half mirror and the user 2. It is sufficient that the position relation between the half mirror 6 and the user 2 is preliminarily selected such that the user 2 stands on the center and in front of the half mirror 6. Alternatively, pressure sensors (not shown) for detecting a position of a center of gravity of the user 2 may be added. In this arrangement, the position relation between the half mirror 6 and the user 2 may be calculated from a detection result of the pressure sensors.

Next, an explanation is made to a brief method for adjusting the display position of the comparison picture. The control device 5 includes a height storage unit (not shown) configured to store a predetermined single value (e.g., 170 cm) as the height of the user 2. Besides, the height stored in the height storage unit may be directly inputted by the user 2.

As long as the position relation between the half mirror 6 and the user 2 is determined, the display control unit 52 can display the comparison picture at a position based on the height of the user 2. Therefore, the display control unit 52 is enabled to display the comparison object at a location superimposed on the mirror image of the user 2 when viewed from the point of view of the user 2.

The following explanation is made to another method. In a situation where the height of the user 2 is not stored in the height storage unit, a position of a particular part (e.g., a head) of the mirror image reflected on the half mirror can be determined based on the position and the direction of the distance image sensor 4, a position on which the user 2 stands, and a position of the top of the head of the user 2. Hence, the display control unit 52 can display the comparison object at a location superimposed on the mirror image of the user 2 when viewed from the point of view of the user 2.

Besides, the adjustments of the display size and the display position of the comparison object may be performed by manually in the initial setting process or may be performed automatically.

As a result, as shown in FIG. 2, the mirror image 20 of the user 2 is reflected on the front face of the half mirror 6, as well as the picture (comparison picture) of the comparison object (instructor) 31 indicative of the posture used as the example passes through the half mirror 6 to be reflected on the front face of the half mirror 6. Thus, the half mirror 6 functions as a mirror image display means configured to display the mirror image of the user 2 such that the mirror image 2 is superimposed onto the comparison image. Hence, the user 2 can exercise while watching the user's mirror image 20 reflected on the half mirror 6 and the comparison object 31 in the comparison picture and comparing the mirror image 20 with the comparison object 31. Besides, in FIG. 2, the mirror image 20 of the user 2 is expressed by a dashed line, and the comparison object 31 in the comparison picture displayed on the display screen is expressed by a solid line.

Further, since the comparison picture is displayed such that the comparison object 31 in the comparison picture is superimposed on the mirror image 20 of the user 2, there is an advantage in that the user 2 can easily understand how to move the body from the comparison picture. In brief, when the user 2 looks at its own mirror image 20, the picture of the comparison object 31 comes into the field of view of the user 2. Hence, the user 2 can compare one's mirror image 20 with the comparison object 31 in the comparison picture without substantial movement of one's line of sight. Moreover, the right side of the body of the comparison object 31 is displayed superimposed on the right side of the body of the mirror image of the user 2, and the left side of the body of the comparison object 31 is displayed superimposed on the left side of the body of the mirror image of the user 2. Thus, the user 2 can easily distinguish the right and left motions of the comparison object 31.and it is possible to facilitate understandings of the user 2 about how to move its body.

In the present embodiment, the user 2 can focus on either of the mirror image 20 reflected on the half mirror 6 and the comparison picture displayed on the display device 3 by switching the focal distance of the eye (the focal distance of picture focal distance of mirror image=1:2). Accordingly, the user 2 can exercise to correct its posture in such a manner to coincide with the posture of the comparison object 31 while recognizing its mirror image 20 and the comparison object 31 in the comparison picture.

Moreover, it is desirable that the luminance of the display device 3 and the brightness in the room are appropriately adjusted during the usage of the exercise assisting system 1 such that there is no significant difference in the appearance seen from the user 2 between the mirror image 20 reflected on the half mirror 6 and the comparison picture displayed on the display device 3.

Besides, the storage unit 51 may be configured to further store a reference picture defined by a dynamic image obtained by taking the image of the comparison object (instructor) in another direction (e.g., a lateral direction) different from the front direction. The display control unit 52 may be configured to display the reference picture on the display device 3 together with the comparison picture. In this instance, it is preferable that the reference picture and the comparison picture are not overlapped with each other. For example, the reference picture is displayed on the side of the comparison picture within the display screen 30. When the reference picture is displayed on the display device 3, the user 2 can refer to the reference picture in order to understand how to move the user's body in the forward and rearward direction. Hence, the user 2 can easily move its body in accordance with the comparison object 31 in the comparison picture.

The display control unit 52 is not always configured to display the comparison object 31 of the comparison picture at a position superimposed on the mirror image 20 of the user 2. For example, the display control unit 52 may display the comparison object 31 on a lateral side, an upper side, or a lower side of the mirror image 20 of the user 2 within the display screen 30. When the comparison object 31 is displayed at a position superimposed on the mirror image 20 of the user 2, it is not necessary to perfectly superimpose the comparison object 31 in the comparison picture on the mirror image 20 of the user 2. For example, it is sufficient that the comparison object 31 and the mirror image 20 are overlapped with each other at their corresponding reference portions (e.g., a foot).

In the exercise assisting system 1 of the present embodiment, the distance image of the user 2 generated by the distance image sensor 4 is outputted to the control device 5, and thus is used for a process of identifying the posture of the user 2. In more detail, the control device 5 is constructed by use of a computer, and includes an acquisition unit 53, and a first extraction unit (characteristic amount extraction unit) 54. The acquisition unit 53 is configured to acquire the distance image from the distance image sensor 4. The first extraction unit 54 is configured to extract a first characteristic amount indicative of the posture of the user 2 from the obtained distance image. Further, the control device 5 includes a second extraction unit (criterion amount extraction unit) 55, an estimation unit 56, and a presentation unit 57. The second extraction unit 55 is configured to extract a second characteristic amount indicative of the posture of the comparison object 31. The estimation unit 56 is configured to estimate a deviation between the postures of the user 2 and the comparison object 31. The presentation unit 57 is configured to present an estimation result given by the estimation unit 56.

The first extraction unit 54 detects a position of a specific point of the user 2 in the distance image by user of an image-recognition technique, and extracts the first characteristic amount indicative of the posture of the user 2 based on the detected position of the specific point. In other words, the first extraction unit (characteristic amount extraction unit) is configured to detect (identify) a position of predetermined one or more sampling points (specific points) 22 of the body of the user 2 and calculate the characteristic amount (first characteristic amount) representing the posture of the user 2 based on the one or more sampling points 22. In this embodiment, the specific points are be selected from points associated with positions, such as a center line of a body trunk, a top of a head, a shoulder, an elbow, a hand, a lower back, a knee, and ankle of the user 2. The specific points are not limited to the aforementioned points, but may be associated with a specific position such as an end of fingers of the user 2 in the distance image. The first extraction unit 54 extracts the first characteristic amount indicative of the posture of the user 2 on the basis of the positions of the respective specific points detected by use of such a manner.

The second extraction unit 55 detects a position of a specific point of the comparison object 31, and extracts the second characteristic amount indicative of the posture of the comparison object 31 based on the detected position of the specific point. In other words, the second extraction unit (criterion amount extraction unit) is configured to detect (identify) a position of predetermined one or more sampling points (specific points) 33 of the body of the comparison object (exerciser) 31 and calculate the criterion amount (second characteristic amount) representing the posture of the comparison object 31 based on the one or more sampling points 33. The position of the specific point of the comparison object 31 is detected from the distance image obtained by the distance image sensor 4 in a process of taking the comparison picture.

The estimation unit 56 estimates the deviation between the postures of the user 2 and the comparison object 31 by comparing the first characteristic amount with the second characteristic amount. In other words, the estimation unit (posture estimation unit) 56 is configured to compare the characteristic amount (first characteristic amount) calculated by the first extraction unit (characteristic amount extraction unit) 54 with the criterion amount (second characteristic amount) representing the posture of the exerciser (comparison object) and perform estimation of the deviation between the posture of the user 2 and the posture of the exerciser.

The presentation unit 57 presents the deviation between the postures of the user 2 and the comparison object 31 estimated by the estimation unit 56, to the user 2. In other words, the presentation unit 57 is configured to give a result of the estimation performed by the estimation unit (posture estimation unit) 56. For example, the presentation unit 57 informs the user 2 of the estimation result of the estimation unit 56 by use of sound or light in response to instructions from the display control unit 52. Alternatively, the estimation result of the estimation unit 56 may be displayed by the display device 3 in response to the instructions from the display control unit 52. In brief, the display device 3 may be configured to function as the presentation unit 57.

The following detailed explanations are made to respective operations of the first extraction unit 54, the second extraction unit 55, the estimation unit 56, and the presentation unit 57.

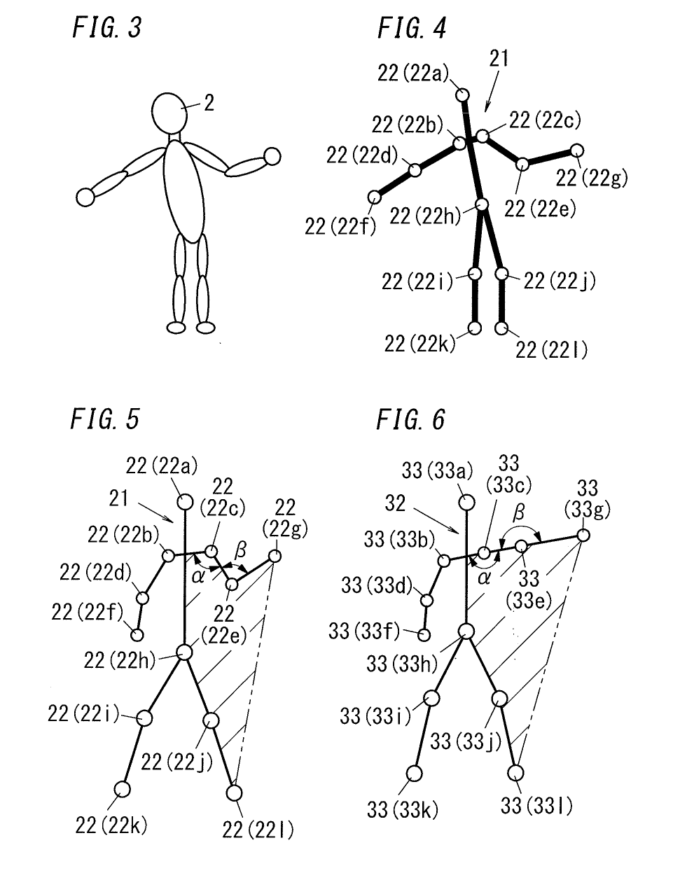

In the present embodiment, the first extraction unit 54 detects the plural specific points 22 from the entire body of the user 2 as shown in FIGS. 3 and 4, and connects the detected specific points with straight lines to create a human body model (hereinafter, referred to as “first human body model”) 21 representing the posture of the user 2 in the three dimensional space. In brief, the first extraction unit 54 creates the first human body model 21 as shown in FIG. 4 from the distance image of the user 2 in the posture illustrated by FIG. 3. In other words, the first extraction unit (characteristic amount extraction unit) 54 is configured to detect the plural sampling points 22 of the body of the user 2 and create the human body model (first human body model) 21 representing the body of the user 2 based on positions of the respective plural sampling points and calculate the characteristic amount (first characteristic amount) based on the human body model 21. In the present embodiment, the plural sampling points 22 of the body of the user 2 include the sampling point 22 (22a) associated with a head of the user 2, the sampling point 22 (22b) associated with a right shoulder of the user 2, the sampling point 22 (22c) associated with a left shoulder of the user 2, the sampling point 22 (22d) associated with a right elbow of the user 2, the sampling point 22 (22e) associated with a left elbow of the user 2, the sampling point 22 (22f) associated with a right hand of the user 2, the sampling point 22 (22g) associated with a left hand of the user 2, the sampling point 22 (22h) associated with a lower back of the user 2, the sampling point 22 (22i) associated with a right knee of the user 2, the sampling point 22 (22j) associated with a left knee of the user 2, the sampling point 22 (22k) associated with a right foot of the user 2, and the sampling point 22 (22l) associated with a left foot of the user 2. The first extraction unit 54 creates the first human body model 21 based on the twelve sampling points 22a to 22l (see FIG. 4).

Besides, the distance image of the user 2 produced by the display device 3 is a dynamic image showing the picture of the user 2 which changes in response to the actual motion of the user 2. Thus, the first human body model 21 constituted by frames of the distance image indicates a real time motion of the user 2.

As shown in FIG. 1, the distance image sensor 4 is positioned over the user 2. Thus, the image (distance image) of the user 2 created by the distance image sensor 4 is an image of the user 2 taken from an obliquely upward position. In brief, the distance image is an image showing the user 2 distorted. Some errors may be observed with regard to the characteristic amount due to a depression angle of a camera of the distance image sensor 4. The first extraction unit 54 is configured to perform a correction process prior to a process of detecting the sampling points (specific points) 22. In the correction process, the first extraction unit 54 corrects the distance image obtained from the distance image sensor 4 as the distance image obtained by taking the image of the user 2 from a position in front of the user 2. Besides, such a correction process is realized by transforming coordinates of the image by use of a predetermined matrix. The first extraction unit 54 detects the positions of the respective sampling points 22 from the distance image after performing the correction process. Besides, when errors due to the depression angle are not serious, the correction process can be skipped. The distance image sensor 4 may be installed at a position lower than a height position of the eyes of the user 2. For example, the distance image sensor 4 may be installed in the center of the lower end of the front face of the half mirror 6. Also in this arrangement, the first extraction unit 54 is configured to perform the correction process of correcting the distance image obtained by the distance image sensor 4 as the distance image obtained by taking the image of the user 2 from the position in front of the user 2. Alternatively, the distance image sensor 4 may be installed on a right or left side of the user 2. Also in this modification, with performing a correction process in a similar manner as mentioned above, the distance image similar to the distance image obtained by taking the image of the user 2 from the position in front of the user 2 can be obtained.

Further, in the process of creating the first human body model 21, the first extraction unit 54 converts the position of the specific point 22 detected from the distance image from an imaging coordinate system defined in the distance image obtained by the distance image sensor 4 to a display coordinate system defined in a virtual space. The virtual space mentioned above is corresponding to a rectangular parallelepiped space including a position on which the user 2 stands in front of the display device 3, and is a space defined by a three dimensional orthogonal coordinate system having coordinate axes respectively corresponding to the forward and rearward direction, the left and right direction, and the upward and downward direction of the user 2. In brief, the first extraction unit 54 converts the position of the specific point 22 from a polar coordinate system based on the distance image sensor 4 to the three dimensional orthogonal coordinate system defined in the virtual space by use of a predetermined conversion formula, and then creates the first human body model 21.

The second extraction unit 55 creates a human body model (hereinafter, referred to as “second human body model”) 32 (see FIG. 6) representing the posture of the comparison object 31 in the comparison picture. In other words, the second extraction unit (criterion extraction unit) 55 is configured to detect the plural specific points 33 from the body of the comparison object (exerciser) 31, and create a human body model (hereinafter, referred to as “second human body model”) 32 representing the body of the comparison object 31 based on the positions of the respective sampling points, and calculate the criterion amount (second characteristic amount) based on the human body model 32. In the present embodiment, the plural sampling points 33 of the body of the comparison object (exerciser) 31 include the sampling point 33 (33a) associated with a head of the comparison object 31, the sampling point 33 (33b) associated with a right shoulder of the comparison object 31, the sampling point 33 (33c) associated with a left shoulder of the comparison object 31, the sampling point 33 (33d) associated with a right elbow of the comparison object 31, the sampling point 33 (33e) associated with a left elbow of the comparison object 31, the sampling point 33 (33f) associated with a right hand of the comparison object 31, the sampling point 33 (33g) associated with a left hand of the comparison object 31, the sampling point 33 (33h) associated with a lower back of the comparison object 31, the sampling point 33 (33i) associated with a right knee of the comparison object 31, the sampling point 33 (33j) associated with a left knee of the comparison object 31, the sampling point 33 (33k) associated with a right foot of the comparison object 31, and the sampling point 33 (33l) associated with a left foot of the comparison object 31. The second extraction unit 55 creates the second human body model 32 based on the twelve sampling points 33a to 33l (see FIG. 6).

The second human body model 32 representing the posture of the comparison object 31 is created from the distance image obtained by the distance image sensor 4 in a similar manner as the first human body model 21 in a process of taking the comparison picture. Besides, like the first extraction unit 54, the second extraction unit 55 is configured to perform a correction process prior to a process of detecting the sampling points (specific points) 33. In this correction process, the second extraction unit 55 corrects the distance image obtained from the distance image sensor 4 as the distance image obtained by taking the image of the comparison object 31 from a position in front of the comparison object 31. To create the second human body model 32, the second extraction unit 55 connects with straight lines the specific points 22 detected from the distance image obtained in the process of taking the comparison picture. Like the first human body model 21, the second human body model 32 is created based on the three dimensional orthogonal coordinate system (display coordinate system) defined in the virtual space. The second human body model 32 created through the aforementioned process may be preliminarily stored in the storage unit 51 together with the comparison picture. Besides, when the criterion amount is preliminarily stored in the storage unit 41, the second extraction unit 55 can be omitted.

The first human body model 21 created may be displayed by the display control unit 52 on a position superimposed on the mirror image 20 of the user 2 within the display screen 30, or a position on a lateral side, an upper side, or a lower side of the mirror image 20 of the user 2 within the display screen 30. Similarly, the second human body model 32 created may be displayed by the display control unit 52 on a position superimposed on the comparison object 31 in the comparison picture, or a position on a lateral side, an upper side, or a lower side of the comparison object 31 within the display screen 30. When the first human body model 21 and the second human body model 32 are displayed, the user 2 can exercise with recognizing the both human body models displayed on the display screen 30. Hence, it can be easy for the user 2 to understand which part of the user's body shows a motion not synchronized with the comparison object 31.

In this embodiment, the first extraction unit 54 calculates an angle of the straight line connecting the specific points 22 relative to a predetermined criterion line from the first human body model 21 and adopts the calculated angle as the first characteristic amount. In other words, the characteristic amount (first characteristic amount) is defined as an angle between the predetermined criterion line and the line connecting the two sampling points 22 selected from the plural sampling points 22 with regard to the first human body model 21. For example, as for the specific point 22 (22c) corresponding to the right shoulder of the first human body model 21 shown in FIG. 5, when the straight line connecting the right shoulder and the left shoulder (the line connecting the sampling points 22c and 22b) is adopted as the criterion line, an angle “α” of the straight line connecting the right shoulder and the right elbow (the line connecting the sampling points 22c and 22b) relative to the above criterion line is obtained. This angle “α” is corresponding to an angle at a joint of the right shoulder. Furthermore, as for the specific point 22 (22e) corresponding to the right elbow of the first human body model 21, when the straight line connecting the right shoulder and the right elbow (the line connecting the sampling points 22c and 22e) is adopted as the criterion line, an angle “β” of the straight line connecting the right elbow and the right hand (the line connecting the sampling points 22e and 22g) relative to the above criterion line is obtained. This angle “β” is corresponding to an angle at a joint of the right elbow.

Similarly, the second extraction unit 55 calculates an angle of the straight line connecting the specific points 33 relative to a predetermined criterion line from the second human body model 32 and adopts the calculated angle as the second characteristic amount. In other words, the criterion amount (second characteristic amount) is defined as an angle between the predetermined criterion line and the line connecting the two sampling points 33 selected from the plural sampling points 33 with regard to the second human body model 32. For example, as for the second human body model 32 as shown in FIG. 6, the angle “α” at the joint of the right shoulder and the angle “β” at the joint of the right elbow are obtained.

In brief, the first extraction unit 54 adopts an angle at a certain joint obtained from the first human body model 21 as the first characteristic amount, and the second extraction unit 55 adopts an angle at a certain joint obtained from the second human body model 32 as the second characteristic amount.

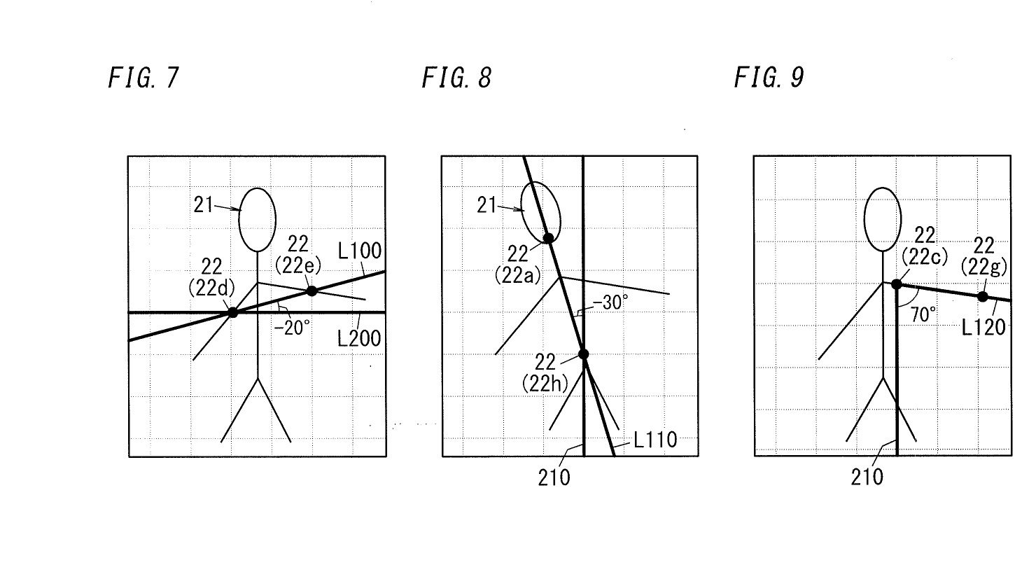

Alternatively, the characteristic amount (first characteristic amount) may be defined as an inclination of the body of the user 2. For example, the inclination of the body of the user 2 is defined as an inclination of the shoulder of the user2 (see FIG. 7). In this example, the first extraction unit (characteristic amount extraction unit) 54 is configured to detect the positions of the sampling points 22 respectively associated with a right upper limb and a left upper limb of the user 2. In an instance shown in FIG. 7, the sampling point 22e at the right elbow is corresponding to the sampling point 22 associated with right upper limb, and the sampling point 22d at the left elbow is corresponding to the sampling point 22 associated with left upper limb. Alternatively, the sampling point 22c at the right shoulder may be adopted as the sampling point 22 associated with the right upper limb, and the sampling point 22b at the left shoulder may be adopted as the sampling point 22 associated with the left upper limb. The first extraction unit 54 is configured to calculate an angle between a straight line L100 connecting the sampling point 22 associated with the right upper limb and the sampling point 22 associated with the left upper limb and a horizontal line L200, as the inclination of the shoulder of the user 2. In the instance shown in FIG. 7, the inclination of the shoulder of the user 2 is −20°. The inclination of the shoulder of the user 2 is defined such that the inclination of the shoulder of the user 2 is negative while an inclination of the straight line L100 is positive and the inclination of the shoulder of the user 2 is positive while the inclination of the straight line L100 is negative.

Alternatively, for example, the inclination of the body of the user 2 is defined as an inclination of a body trunk of the user 2. In this example, the first extraction unit (characteristic amount extraction unit) 54 is configured to detect the positions of the sampling points 22a and 22h respectively associated with the head and the lower back of the user 2, and calculate an angle between a vertical line L210 and a straight line L110 connecting the sampling points 22a and 22h of the head and the lower back, as the inclination of the body trunk of the user 2. In an instance shown in FIG. 8, the inclination of the body trunk of the user 2 is −30°. The inclination of the body trunk of the user 2 is defined such that the inclination of the body trunk of the user 2 is positive while an inclination of the straight line L110 is positive and the inclination of the body trunk of the user 2 is negative while the inclination of the straight line L110 is negative.

The criterion amount extraction unit 55 can calculate an inclination of the body of the comparison object 31 (an inclination of a shoulder or a body trunk), as the criterion amount (second characteristic amount), in a similar manner as mentioned above.

Alternatively, the characteristic amount (first characteristic amount) may be defined to represent a range of motion of a certain portion of the body of the user 2. For example, the certain portion is the upper limb of the user 2 (see FIG. 9). In an instance shown in FIG. 9, the certain portion is the right upper limb. In this instance, the first extraction unit (characteristic amount extraction unit) 54 detects the position of the sampling point 22 associated with the upper limb (the sampling point 22g at the right hand) of the user 2 and the position of the sampling point 22 associated with the shoulder corresponding to this upper limb (the sampling point 22c at the right shoulder) of the user 2. The sampling point 22e at the right elbow may be adopted as the sampling point 22 associated with the upper limb of the user 2. The first extraction unit 54 is configured to calculate an angle between the vertical line L210 and a straight line L120 connecting the sampling point 22 (22g) of the upper limb and the sampling point 22 (22c) of the shoulder, as the range of motion of the upper limb. In the instance shown in FIG. 9, the first extraction unit 54 calculates the range of motion of the right upper limb of the user 2, and this range is 70°.

Alternatively, the certain portion may be the left upper limb. In this instance, the first extraction unit (characteristic amount extraction unit) 54 may detect the position of the sampling point 22 associated with the upper limb (e.g., the sampling point 22f at the left hand and the sampling point 22d at the left elbow) of the user 2 and the position of the sampling point 22 associated with the shoulder corresponding to this upper limb (the sampling point 22b at the left shoulder) of the user 2.

Alternatively, the certain portion may be a lower limb (e.g., a right lower limb and a left lower limb). In this instance, the first extraction unit 54 is configured to calculate an angle between the vertical line L210 and a straight line (not shown) connecting the sampling point 22 associated with the lower limb (e.g., the sampling points 22i, 22k, 22j, and 22l respectively associated with the left knee, the left foot, the right knee, and the right foot) and the sampling point 22h associated with the lower back, as the range of motion of the lower limb.

The criterion amount extraction unit 55 can calculate a range of motion of a certain portion (e.g., an upper limb and a lower limb) of the body of the comparison object 31, as the criterion amount (second characteristic amount), in a similar manner as mentioned above.

The first human body model 21 is not limited to a human body model created from the distance image capturing the front of the user 2, but may be a human body model created from the distance image capturing the side of the user 2. For example, with detecting the positions of the feet and the position of the center of gravity of the user 2 by use of a pressure sensor installed a site on which the user 2 stands, it is possible to judge whether the distance image sensor 4 faces the front or the side of the body of the user 2 based on the detection result. Upon acknowledging that the distance image sensor 4 faces the front of the user based on the judgment result, the first extraction unit 54 creates the first human body model 21 representing the front of the user 2. Upon acknowledging that the distance image sensor 4 faces the side of the user 2 based on the judgment result, the first extraction unit 54 creates the first human body model 21 representing the side of the user by rotating the human body model representing the front of the body of the user around the vertical axis by 90°.

With using the first human body model 21 representing the side of the body of the user created in the above mentioned manner, it is possible to calculate a motion in. the forward and rearward direction of the body of the user (e.g., an anterior inclination and a posterior inclination of a straight line connecting a shoulder and a lower back) as the first characteristic amount. Similarly, the second human body model 32 also may be a human body model representing the side of the body. When these human body models representing the side of the body are displayed on the display screen 30 by the display control unit 52, the user 2 can check the motion of the body of the user in the forward and rearward direction based on these human body models.

To estimate the deviation between the postures of the user 2 and the comparison object 31, the estimation unit 56 compares the angle at the joint extracted as the first characteristic amount from the first human body model 21 with the angle at the joint extracted as the second characteristic amount from the second human body model 32. With comparing the angles at the joint, the estimation unit 56 can ignore a difference (e.g., a length of an arm) between the user 2 and the comparison object 31 and objectively estimate the deviation between the postures of the user 2 and the comparison object 31. Besides, the estimation unit 56 may perform comparison between the human body models with regard to angles at plural joints or an angle at a particular joint.

In this embodiment, the estimation unit 56 calculates a difference between the first characteristic amount and the second characteristic amount. The estimation unit 56 may convert a degree of the deviation between the postures of the user 2 and the comparison object 31 to a numerical value based on the calculated difference. Further, the estimation unit 56 may judge based on the calculated difference whether or not the deviation between the user 2 and the comparison object 31 occurs. In the present embodiment, the estimation unit 56 makes an estimation by use of the characteristic amounts respectively extracted from the first human body model 21 and the second human body model 32 which are three dimensional models. Hence, the 56 can estimate a deviation in a depth direction (a direction normal to the display screen 30) in addition to the deviation within a plane parallel to the display screen 30.

The presentation unit 57 may present information simply indicating a judgment result of whether or not the posture of the user 2 is deviated from the posture of the comparison object 31, or the degree of such a deviation. Further, when the estimation unit 56 particularly judges which part of the body is deviated and which direction is a direction in which such a part of the body is deviated, the presentation unit 57 may present advice for reducing such a deviation. As for an exercise of extending a right arm out to a side sufficiently, when the joint of the right elbow of the user 2 is bent, the presentation unit 57 presents advice stating “extend your arm”, for example.

When the display device 3 is used as the presentation unit 57, the display control unit 52 highlights a part of the comparison picture greatly deviated from the posture of the user 2, by changing its color. Thus, the user 2 can understand a part which the user 2 fails to move correctly. For example, as for an exercise of extending a right arm out to a side sufficiently, when the right arm of the user 2 is not sufficiently moved upwardly and is deviated from the right arm of the comparison object 31, the display control unit 52 highlights the right arm part of the comparison object 31 in the comparison picture, and presents the deviation of the right arm part to the user 2. Hence, the user 2 can exercise with paying attention to the part deviated from the comparison object 31, and can easily exercise in accordance with the comparison object 31 in the comparison picture.

As mentioned above, the presentation unit 57 can present which part of the body of the user 2 is deviated from the comparison object 31 or a direction in which the part of the body of the user is deviated from the comparison object 31. Hence, the user 2 can learn the right exercise.

Furthermore, when the estimation unit 56 converts the degree of the deviation between the postures of the user 2 and the comparison object 31 to the numerical value based on the difference between the first characteristic amount and the second characteristic amount, the presentation unit 57 may present this numerical value representing the degree of the deviation. In other words, the estimation unit (posture estimation unit) 56 is configured to calculate the numerical value indicative of the difference between the characteristic amount (first characteristic amount) and the criterion amount (second characteristic amount), and the presentation unit 57 is configured to present the numerical value calculated by the posture estimation unit 56. For example, the presentation unit 57 may present the difference value between the first characteristic amount and the second characteristic amount without changing it. The presentation unit 57 may present a point representing a degree of coincidence between the postures of the user 2 and the comparison object 31 calculated based on the difference value. In this manner, the presentation unit 57 can present the degree of the deviation or the degree of the coincidence.

As mentioned above, with quantifying and presenting the degree of the deviation or the coincidence between the postures of the user 2 and the comparison object 31, the user 2 can use the presented value as an indication a learning level of the exercise, and easily estimate an exercise effect. Besides, the presentation unit 57 may classify the numerical value representing the degree of the coincidence between the postures of the user 2 and the comparison object 31 into plural ranks, and presets the rank corresponding to the degree of the coincidence.

As another instance, the first extraction unit 54 may calculate an area of a region surrounded by the straight lines connecting the plural specific points 22 from the first human body model 21, and adopt the calculated area as the first characteristic amount. In other words, the number of the sampling points 22 of the first human body model 21 may be three or more, and the characteristic amount (first characteristic amount) may be an area of a closed region defined by the sampling points. For example, with regard to the right shoulder, the right elbow, the right hand, the body trunk, the right knee, and the right foot of the first human body model 21, the area of the region (the hatched part in the drawing) surrounded by the straight lines connecting these specific points 22 is obtained. Similarly, the second extraction unit 55 calculates an area of a region (the hatched part in the drawing) surrounded by the straight lines connecting the right shoulder, the right elbow, the right hand, the body trunk, the right knee, and the right foot of the second human body model 32 shown in FIG. 6, and adopts the calculated area as the second characteristic amount. In other words, the number of the sampling points of the second human body model 32 may be three or more, and the criterion amount (second characteristic amount) may be an area of a closed region defined by the sampling points.

With this modification, to estimate the deviation between the postures of the user 2 and the comparison object 31, the estimation unit 56 compares the area extracted as the first characteristic amount from the first human body model 21 with the area extracted as the second characteristic amount from the second human body model 32. The area obtained through the aforementioned process represents a tendency (e.g., a degree of extension of a body). Thus, the estimation unit 56 can roughly estimate the deviation between the postures of the user 2 and the comparison object 31 based on comparison between the areas. Besides, the estimation unit 56 may perform comparison between the human body models with regard to areas of plural regions or an area of a single region.

As mentioned in the above, the exercise assisting system 1 of the present embodiment includes the display device 3, the half mirror 6, the storage unit 51, and the display control unit 52. The display device 3 displays a picture on the display screen 30 which is placed in front of the user 2 and faces the user 2. The half mirror 6 is placed on the user 2 side of the display screen 30. The storage unit 51 stores the picture of the comparison object 31 which performs the exercise identical to the exercise to be performed by the user 2 as the comparison picture. The display control unit 52 displays the comparison picture on the display device 3 while the user 2 exercises. Further, the exercise assisting system 1 includes the first extraction unit 54, the second extraction unit 55, the estimation unit 56, and the presentation unit 57. The first extraction unit 54 detects the position of the specific point of the body of the user 2 and extracts the first characteristic amount representing the posture of the user 2 based on the detected specific point. The second extraction unit 55 detects the position of the specific point of the comparison object 31 and extracts the second characteristic amount representing the posture of the comparison object 31 based on the detected specific point. The estimation unit 56 compares the first characteristic amount with the second characteristic amount and estimates the deviation between the postures of the user 2 and the comparison object 31. The presentation unit 57 presents the estimation result of the estimation unit 56.

In other words, the exercise assisting system 1 of the present embodiment includes the display device 3, the storage unit (comparison image storage unit) 51, the display control unit (comparison image display unit) 52, the mirror image displaying means, the first extraction unit (characteristic amount extraction unit) 54, the estimation unit (posture estimation unit) 56, and the presentation unit 57. The display device 3 includes the display screen 30 for displaying an image to the user 2. The comparison image storage unit 51 is configured to store the comparison image defined as the image of the exerciser performing the predetermined exercise. The comparison image display unit 52 is configured to display the comparison image stored in the comparison image storage unit 51 on the display screen 30. The mirror image displaying means is configured to display the mirror image of the user 2 such that the mirror image is superimposed onto the comparison image. The characteristic amount extraction unit 54 is configured to detect the position of the predetermined one or more sampling points of the body of the user 2 and calculate the characteristic amount (first characteristic amount) representing the posture of the user 2 based on the position of the one or more sampling points. The posture estimation unit 56 is configured to compare the characteristic amount calculated by the characteristic amount extraction unit 54 with the criterion amount (second characteristic amount) representing the posture of the exerciser and perform the estimation of the deviation between the posture of the user 2 and the posture of the exerciser. The presentation unit 57 is configured to give the result of the estimation performed by the posture estimation unit 56.

In the exercise assisting system 1 of the present embodiment, the mirror image displaying means is the half mirror 6 placed in front of the display device 3.

Further, the exercise assisting system 1 of the present embodiment includes the criterion amount extraction unit (second extraction unit) 55. The criterion amount extraction unit 55 is configured to detect the position of the predetermined one or more sampling points (specific points) of the body of the exerciser (comparison object 31) in the comparison image and calculate the criterion amount (second characteristic amount) representing the posture of the exerciser based on the position of the one or more sampling points.

According to the exercise assisting system 1 as explained in the above, the user 2 can exercise while comparing its mirror image 20 reflected on the half mirror 6 with the comparison object 31 in the comparison picture displayed on the display screen 30. Hence, the user 2 can easily exercise in accordance with the comparison object 31. Consequently, it can be easy for the user 2 to learn the right posture (motion) of the exercise. Thus, the user can acquire the sufficient exercise effect.

Further, the estimation unit 56 compares the first characteristic amount representing the posture of the user 2 with the second characteristic amount representing the posture of the second human body model 32 and estimates the deviation between the postures of the user 2 and the comparison object 31. The estimation result of the estimation unit 56 is presented by the presentation unit 57. Therefore, the user 2 can recognize the deviation between the postures of the user 2 and the comparison object 31. In other words, the user 2 can recognize how much difference between its posture and the posture of the comparison object 31 in the comparison picture. Hence, when the user 2 is performing an exercise greatly deviated from the posture of the comparison object 31, the exercise assisting system 1 can present such fact to the user 2. Thus, the user 2 can improve its motion. The user 2 can easily learn the right posture of the exercise.

Beside, in the exercise assisting system 1 of the present embodiment, the comparison picture is a picture of the comparison object 31 representing a model of the exercise to be performed by the user 2. In other words, the predetermined exercise is a model of an exercise performed by the user 2.

In the exercise assisting system 1 of the present embodiment, each of the first extraction unit 54 and the second extraction unit 55 detects the positions of the respective plural specific points, and connects the specific points to create the human body model, and extracts the characteristic amount from the created human body model. In other words, the characteristic amount extraction unit (first extraction unit) 54 is configured to detect the positions of the respective plural sampling points (specific points) of the body of the user 2 and create the human body model (first human body model) 21 representing the body of the user 2 based on the positions of the respective plural sampling points and calculate the characteristic amount (first characteristic amount) based on the human body model 21. Further, the criterion amount extraction unit (second extraction unit) 55 is configured to detect the positions of the respective plural sampling points (specific points) of the body of the comparison object 31 in the comparison image and create the human body model (second human body model) 32 representing the body of the comparison object 31 based on the positions of the respective plural sampling points and calculate the criterion amount (second characteristic amount) based on the human body model 32.

Further, in the exercise assisting system 1 of the present embodiment, the first extraction unit 54 and the second extraction unit 55 adopts the angle of the straight line connecting the plural specific points relative to the predetermined criterion line as the characteristic amount. In other words, the characteristic amount is defined as the angle between the predetermined criterion line and the straight line connecting the two sampling points selected from the plural sampling points.

Moreover, in the exercise assisting system 1 of the present embodiment, the characteristic amount (first characteristic amount) may be defined as the inclination of the body of the user 2. Especially, the inclination of the body of the user 2 is defined as the inclination of the shoulder of the user 2. In this example, the characteristic amount extraction unit 54 is configured to detect the positions of the sampling points 22 of the right and left upper limbs of the user 2, and calculate the angle between the horizontal line L200 and the straight line L100 connecting the sampling points 22 of the right and left upper limbs, as the inclination of the shoulder of the user 2. Alternatively, the inclination of the body of the user 2 may be defined as the inclination of the body trunk of the user 2. In this example, the characteristic amount extraction unit 54 is configured to detect the positions of the sampling points 22 of the head and the lower back of the user 2, and calculate the angle between the vertical line L210 and the straight line L110 connecting the sampling points 22 of the head and the lower back, as the inclination of the body trunk of the user 2. Similarly, in the exercise assisting system 1 of the present embodiment, the criterion amount extraction unit 55 may calculate the inclination of the body (the inclination of the shoulder or the body trunk) of the comparison object 31 as the criterion amount (second characteristic amount).

Furthermore, in the exercise assisting system 1 of the present embodiment, the characteristic amount (first characteristic amount) may represent the range of motion of the certain portion of the body of the user 2. Especially, the certain portion may be the upper limb of the user 2. In this example, the characteristic amount extraction unit 54 is configured to detect the positions of the sampling points 22 of the upper limb and the shoulder connected to the upper limb of the user 2 and calculate the angle between the vertical line L210 and the straight line L120 connecting the sampling points 22 of the upper limb and the shoulder as the range of motion of the upper limb. Similarly, in the exercise assisting system 1 of the present embodiment, the criterion amount extraction unit 55 may calculate a range of motion of a certain portion (e.g., an upper limb) of the comparison object 31 as the criterion amount (second characteristic amount).

In the exercise assisting system 1 of the present embodiment, each of the first extraction unit 54 and the second extraction unit 55 adopts the area of the region surrounded by the straight lines connecting the specific points as the characteristic amount. In other words, the number of the sampling points is three or more, and the characteristic amount is the area of the closed region defined by the sampling points.

In the exercise assisting system 1 of the present embodiment, the display control unit 52 adjusts the position and the size of the comparison picture 31 on the display screen 30 such that the pictures of the user 2 and the comparison object 31 appear to be overlapped with each other for the user 2. In other words, the comparison image display unit (display control unit) 52 is configured to adjust at least one of the position and the size of the comparison image on the display screen 30 such that the comparison image is superimposed on the mirror image of the user.

In the exercise assisting system 1 of the present embodiment, the estimation unit 56 converts the difference between the first characteristic amount and the second characteristic amount to the numerical value and has the presentation unit 57 present the numerical value. In other words, the posture estimation unit (estimation unit) 56 is configured to calculate the numerical value indicative of the difference between the characteristic amount (first characteristic amount) and the criterion amount (second characteristic amount). The presentation unit 57 is configured to present the numerical value calculated by the posture estimation unit 56.

The present embodiment shows an instance where the first extraction unit 54 and the second extraction unit 55 detect the specific points 22 from the entire bodies of the user 2 and the comparison object 31 and extract the characteristic amounts by use of the human body models corresponding to the entire bodies of the user 2 and the comparison object 31, respectively. The present embodiment is not limited to this instance. In another instance, the first extraction unit 54 may adopt a coordinate position of a certain specific point 22 of the user 2 as the first characteristic amount and the second extraction unit 55 may adopt a coordinate position of a certain specific point 22 of the user 2 as the second characteristic amount.

In this instance, the estimation unit 56 compares the first characteristic amount with the second characteristic amount, and then estimates a deviation of the specific point 22 corresponding to the same part of the body between the user 2 and the comparison object 31. For example, the body trunk of the user 2 coincides with the body trunk of the comparison object 31, and each of the first characteristic amount and the second characteristic amount is the coordinate position of the specific point 22 corresponding to the right hand. To estimate the deviation of the position of the right hand between the user 2 and the comparison object 31, the estimation unit 56 calculates the difference between the characteristic amounts. In other words, the estimation unit 56 calculates a relative distance between the user 2 and the comparison object 31 with regard to the specific point 22 corresponding to the same part of the body and estimates the deviation between the postures of the user 2 and the comparison object 31.

In addition, for example, the estimation unit 56 may judge whether or not the specific point 22 associated with the right hand is in a position higher than that of the specific point 22 associated with the right shoulder. In brief, the estimation unit 56 may estimate the deviation between the postures of the user 2 and the comparison object 31 based on a position relation between one specific point 22 and the other specific point 22. For example, as for the exercise of extending the right arm out the side sufficiently, when the specific point 22 associated with the right hand of the user 2 is in a position lower than that of the specific point 22 associated with the right shoulder of the user 2, the presentation unit 57 may present advice indicating “raise your arm higher”.

Further, the two distance image sensors 4 may be placed in front (the half mirror 6 side) and the side of the user 2 respectively, and the acquisition unit 53 may acquire the distance image capturing the front of the user 2 and the distance image capturing the side of the user 2 simultaneously. In this configuration, the inclination in the left and right direction of the body can be extracted from the distance image capturing the front of the user 2 as the characteristic amount and the inclination in the forward and rearward direction of the body can be extracted from the distance image capturing the side of the user 2 as the characteristic amount. Consequently, in comparison to a situation where the characteristic amounts representing the inclinations (postures) in the forward and rearward direction and the left and right direction are extracted from the distance image obtained from the single distance image sensor 4, measurement accuracy can be improved.

Further, the first extraction unit 54 is not limited to a configuration of detecting the specific point of the user 2 by use of the distance image obtained by the distance image sensor 4 as mentioned above. For example, the first extraction unit 54 may detect the position of the specific point of the user 2 by use of a two dimensional image of the user 2 picked up by a two dimensional camera such as a CCD (Charge Coupled Device) camera or a sensor output obtained by a motion capture system having gyro sensors attached to the user 2. Similarly, the second extraction unit 55 may detect the specific point of the comparison object 31 from the other information different from the distance image.

### Second Embodiment

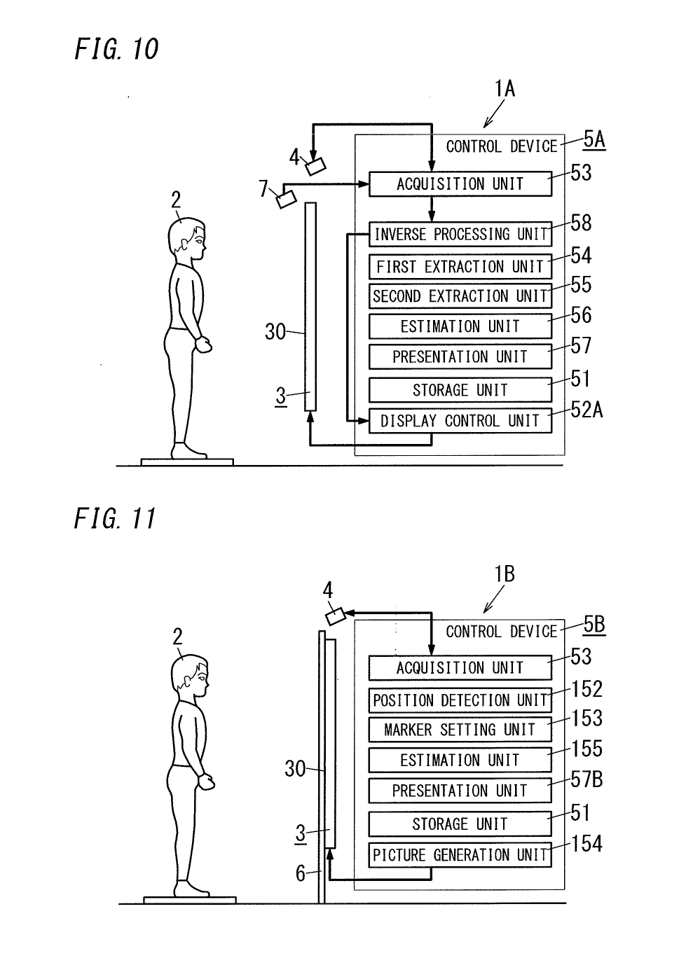

The exercise assisting system 1A of the present embodiment is different from the exercise assisting system 1 of the first embodiment in that the exercise assisting system 1A lacks the half mirror 6. Further, as shown in FIG. 10, the exercise assisting system 1A of the present embodiment is provided an image pickup device 7. The image pickup device 7 is placed in front of the user 2 and has a lens orientated so as to pick up an image of the user 2 from the front.

The image pickup device 7 is configured to shoot the user 2 to create an image of the user 2. The image pickup device 7 is installed at a height position of the eyes of the user 2 on the front side (the user 2 side) of the display device 3 by utilizing, for example, a camera stand, etc. Further, the image pickup device 7 has its tilt angle and pan angle to be adjusted such that the whole body of the user 2 is included in the field of view, and the center line in the left and right direction of the body of the user 2 when the user 2 is in an upright position coincides with the center line of left and right direction of a picked up picture.

The above described adjustment of the position and orientation of the image pickup device 7 is performed as an initial setting after the standing position and the height of the eye line etc. of the user 2 are determined. As a result of this, the image pickup device 7 is allowed to pick up a dynamic image which reflects the whole body of the user 2 (hereafter, referred to as a “whole body picture”).

The control device 5A is connected to both of the display device 3 and the image pickup device 7, and has a function of processing a picture picked up by the image pickup device 7 and causing the display device 3 to display the picture. To be specific, the control device 5A has an inverse processing unit 58 configured to acquire a whole body picture from the image pickup device 7 and reverse the acquired whole body picture from left to right to produce an inverted picture. In other words, the inverse processing unit 58 is configured to reverse the image of the user 2 created by the image pickup device 7 from left to right and create the mirror-reversed image. Further, the control device 5A causes the display device 3 to display the inverted picture such that the center line in the left and right direction of the inverted picture coincides with the center line in the left and right direction of the display screen 30. As a result of this, the whole body picture of the user 2 is flipped from left to right like a mirror image reflected on a mirror and is displayed on the display screen 30 of the display device 3.

The picture picked up by the image pickup device 7 is not reversed from left to right in a similar manner as a mirror image unless the picture is processed. The left and right direction viewed from the user 2 in front of the display screen 30 is an opposite direction from the left and right direction of the picture displayed on the display screen 30. In brief, when the picture of the whole body of the user 2 picked up by the image pickup device 7 is not processed but is displayed on the display screen 30 of the display device 3 in front of the user 2, the left body of the user 2 is reflected on the right side of the display screen 30 and the right body of the user 2 is reflected on the left side of the display screen 30.

In contrast, the inverted picture is a picture obtained by reversing the picture of the whole body from left to right. Thus, the display device 3 displays the inverted picture such that the right body of the user 2 is reflected on the right side of the display screen 30 and the left body of the user 2 is reflected on the left side of the display screen 30. Consequently, with displaying the inverted picture reflected on the display screen 30 to the user 2, the display device 3 can delude the user 2 into thinking that the inverted picture is the mirror image of the whole body of the user.

In this embodiment, the control device 5A processes (inverts) a picture inputted from the image pickup device 7 in real time (about 15 to 30 frames per one second) and outputs a picture signal to the display device 3. The display device 3 receives the picture signal from the control device 5A, and displays an inverted picture in real time. For that reason, a dynamic image which moves in accordance with the actual movement of the user 2 is displayed as an inverted picture on the display screen 30 of the display device 3.

That is, the exercise assisting system 1A of the present embodiment can make the user 2 visually recognize an inverted picture displayed on the display device 3 and cause the user 2 to falsely perceive the inverted picture as a mirror image of its own, without presenting a mirror image which is optically formed.

Further, the display control unit 52A displays on the display device 3, the comparison picture representing the comparison object 31 performing the exercise same as the exercise to be performed by the user 2, together with the inverted picture created by the inverse processing unit 58. The display control unit 52A controls the size adjustment unit and the position adjustment unit in such a manner to adjust the size and the position of the comparison picture on the display screen 30 such that the image of the comparison object (instructor) 31 of the comparison picture is superimposed on the image of the user 2 of the inverted picture within the display screen 30. To enable a user to easily distinguish between the inverted picture and the comparison picture, the display control unit 52A displays one of the inverted picture and the comparison picture as a semi-transparent picture (having, for example, a transmissivity of 50%).

As mentioned in the above, the exercise assisting system 1A of the present embodiment includes the display device 3, the half mirror 6, the image pickup device 7, the inverse processing unit 58, the storage unit 51, and the display control unit 52A. The display device 3 displays a picture on the display screen 30 which is placed in front of the user 2 and faces the user 2. The image pickup device 7 is placed in front of the user 2 and is configured to pick up the picture of the user 2. The inverse processing unit 58 is configured to reverse the picture of the user 2 picked up by the image pickup device 7 from left to right to create the inverted picture. The storage unit 51 stores the picture of the comparison object 31 which performs the exercise identical to the exercise to be performed by the user 2 as the comparison picture. The display control unit 52A displays the comparison picture on the display device 3 together with the inverted picture while the user 2 exercises. Further, the exercise assisting system 1 includes the first extraction unit 54, the second extraction unit 55, the estimation unit 56, and the presentation unit 57. The first extraction unit 54 detects the position of the specific point of the body of the user 2 and extracts the first characteristic amount representing the posture of the user 2 based on the detected specific point. The second extraction unit 55 detects the position of the specific point of the comparison object 31 and extracts the second characteristic amount representing the posture of the comparison object 31 based on the detected specific point. The estimation unit 56 compares the first characteristic amount with the second characteristic amount and estimates the deviation between the postures of the user 2 and the comparison object 31. The presentation unit 57 presents the estimation result of the estimation unit 56.

In other words, the exercise assisting system 1A of the present embodiment includes the display device 3, the storage unit (comparison image storage unit) 51, the display control unit (comparison image display unit) 52A, the mirror image displaying means, the first extraction unit (characteristic amount extraction unit) 54, the estimation unit (posture estimation unit) 56, and the presentation unit 57. The display device 3 includes the display screen 30 for displaying an image to the user 2. The comparison image storage unit 51 is configured to store the comparison image defined as the image of the exerciser performing the predetermined exercise. The comparison image display unit 52 is configured to display the comparison image stored in the comparison image storage unit 51 on the display screen 30. The mirror image displaying means is configured to display the mirror image of the user 2 such that the mirror image is superimposed onto the comparison image. The characteristic amount extraction unit 54 is configured to detect the position of the predetermined one or more sampling points of the body of the user 2 and calculate the characteristic amount (first characteristic amount) representing the posture of the user 2 based on the position of the one or more sampling points. The posture estimation unit 56 is configured to compare the characteristic amount calculated by the characteristic amount extraction unit 54 with the criterion amount (second characteristic amount) representing the posture of the exerciser and perform the estimation of the deviation between the posture of the user 2 and the posture of the exerciser. The presentation unit 57 is configured to give the result of the estimation performed by the posture estimation unit 56.

In the exercise assisting system 1 of the present embodiment, the mirror image displaying means includes the image pickup device 7, the inverse processing unit 58, and the inverted image display unit (display control unit) 52A. The image pickup device 7 is configured to shoot the user 2 to create the image of the user 2. The inverse processing unit 58 is configured to reverse the image of the user 2 created by the image pickup device 7 from left to right and create the mirror-reversed image. The inverted image display unit 52A is configured to display the mirror-reversed image created by the inverse processing unit 58 on the display screen 30.

According to the exercise assisting system 1A of the present embodiment described above, there is an advantage in that the configuration can be simplified owing to the omission of the half mirror 6 in contrast to the exercise assisting system 1 of the first embodiment. Furthermore, in the configuration of the present embodiment, if a display having a relatively large screen is preinstalled, the existing display can be used as the display device 3 even without newly providing a dedicated display, and therefore it is possible to reduce the introduction cost of the system.

The other configurations and functions of the exercise assisting system 1A of the present embodiment are the same as those of the exercise assisting system 1 of the first embodiment.

For example, the first and second embodiments adopt the picture of the instructor showing the model of the exercise to be performed by the user 2 as an instance of the comparison picture. The comparison picture is not limited to the above instance. It is sufficient that the comparison picture may be a picture of the comparison object performing the exercise same as the exercise to be performed by the user 2. In other words, the comparison picture may be a picture showing the comparison object such as a computer graphics representing the human body and the aforementioned second human body model. In this instance, the user 2 exercises in accordance with the movement of the computer graphics or the second body model in the comparison picture instead of the picture of the instructor mentioned above.

Alternatively, the control device 5A may store the picture of the user 2 who is exercising taken by an image pickup device placed in front of the user 2 in the storage unit 51, and control the display control unit 52 in such a manner to display the picture on the display device 3 for the next exercise. In brief, the exercise assisting system 1A of the present embodiment may include the image pickup device 7 placed in front of the user 2 and configured to take the picture of the user 2, and the comparison picture may be the picture of the user taken by the image pickup device 7 at a past time. In other words, the exercise assisting system 1A of the present embodiment includes the image pickup device 7 and the criterion amount extraction unit (second extraction unit) 55. The image pickup device 7 is configured to shoot the user 2 performing the predetermined exercise and create a recorded image defined as an image of the user 2 performing the predetermined exercise. The comparison image display unit (display control unit) 52A is configured to display, on the display screen 30, the recorded image created by the image pickup device 7 as the comparison image. The criterion amount extraction unit 55 is configured to detect the position of the predetermined one or more sampling points of the body of the user 2 from the recorded image and calculate the characteristic amount representing the posture of the user 2 based on the position of the one or more sampling points, as the criterion amount. In this instance, when the user 2 exercises, the picture of the user 2 taken by the image pickup device at the past (previous) exercise is displayed on the display screen 30 as the comparison picture.

In this configuration, the user 2 can exercise while comparing the current picture with the previous picture. Hence, the user 2 can exercise while using the comparison object having the same physical constitutions (e.g., a length of an arm) as the user, as the model. Therefore, in contrast to an instance where the picture of the instructor is used as the comparison picture, the user 2 can easily change its posture (movement) in accordance with the comparison object.

Further, in this configuration, to estimate the deviation of the posture between the current picture of the user 2 and the previous picture of the user 2 adopted as the comparison object, the estimation unit 56 compares the first characteristic amount representing the posture of the user 2 with the second characteristic amount representing the posture of the comparison object. Hence, the estimation unit 56 can estimate how the exercise posture of the user changes relative to the previous exercise posture. Thus, the estimation unit 56 can estimate a degree of progress of rehabilitation.

### Third Embodiment

The exercise assisting system 1B of the present embodiment has an aspect as a range-of-motion training system. The range-of-motion training system is used for range-of-motion training for returning a range of motion of a certain portion of a body (e.g., four limbs) to a normal range and maintaining the normal range.

For example, in a field of rehabilitation, generally, range-of-motion training is adopted in order to prevent and remedy limitations on a range (range of motion) of motion of four limbs of a patient due to a disease or injury. The range-of-motion training is performed for returning a range of motion of a certain portion of a body (e.g., four limbs) to a normal range and maintaining the normal range. In the range-of-motion training, a patient moves its certain portion considered as a training object continuously (e.g., every day).

As for the range-of-motion training, generally, a range of motion of a certain portion of a patient is measured, and a measurement result is used for determination of a degree of a problem or an effect of such training (a degree of recovery). For example, a general method of measuring a range of motion of a certain portion may include a method of measuring a height of an arm which is raised by a patient by use of a tape measure and a method of measuring a relative angle between an upper arm and a lower arm of an arm which is bent at an elbow joint by use of an angle meter.

As an angle meter used for such measurement, there has been proposed an angle meter which includes an inclination angle meter for identifying a gravity direction relative to an arm and is designed to enable a measurer to obtain an inclination angle of an upper arm or a lower arm relative to a vertical direction (see document 2 “JP 4445468 B”). According to the angle meter disclosed in document 2, for example, in a process of measuring a relative angle of an upper arm or a lower arm, a relative angle of an upper arm or a lower arm relative to a whole body is also measured. Hence, it is possible to precisely determine a degree of recovery of a user in a field of rehabilitation.

However, in the aforementioned range-of-motion training, a patient can know only a measurement result (e.g., an angle) of a range of motion and cannot sufficiently recognize what is meant by the measurement result unless a specialist (e.g., a therapist) estimates a range of motion of a certain portion based on the measurement result. For example, the measurement result shows a height in centimeter of an arm which is raised by a patient. However, the patient itself cannot understand a degree of recovery or deterioration of a range of motion. Thus, the patient cannot sufficiently understand necessity and effects of the range-of-motion training.

Consequently, it is desirable that the range-of-motion training system can present an estimation result of a range of motion of a certain portion of a body to a user.

The exercise assisting system 1B of the present embodiment is used as a range-of-motion training system. The range-of-motion training system is applied to rehabilitation aiming to prevent and remedy limitations on a range (range of motion) of motion of four limbs of a patient due to a disease or injury. The following embodiments do not give any limitations on application of the range-of-motion training system. For example, the range-of-motion training system can be applied to training for extending a range of motion of four limbs of a normal person or training for preventing limitations on a range of motion of four limbs due to deterioration with age. In the following, a user uses the range-of-motion training system in a standing posture. However, a user may use the range-of-motion training system in a posture sitting in a chair.

As shown in FIG. 11, the exercise assisting system 1B of the present embodiment is different from the exercise assisting system 1 of the first embodiment in the control device 5B. The exercise assisting system 1B of the present embodiment includes the display device 3, the distance image sensor 4, and the control device 5B. The display device 3 is configured to display an image on the display screen 30 placed in front of a user (patient) 2 so as to face the user 2. The distance image sensor 4 is configured to create a distance image. The control device 5B is configured to control operations of the display device 3 and the like. Each of the display device 3 and the distance image sensor 4 is connected to the control device 5B. Further, the exercise assisting system 1B of the present embodiment includes the half mirror 6 defining the mirror image displaying means.

In the exercise assisting system 1B of the present embodiment, the distance image of the user 2 generated by the distance image sensor 4 is outputted to the control device 5B, and thus is used for a process of detecting a position of a certain portion of a body of the user 2.

In more detail, the control device 5B is constructed by use of a computer, and includes the acquisition unit 53, and a position detection unit 152 configured to detect the position of the certain portion by use of the acquired distance image. Further, in the exercise assisting system 1B of the present embodiment, the control device 5B includes a marker setting unit 153 and a picture generation unit 154. The marker setting unit 153 is configured to set a marker at a position on the display screen 30 corresponding to the position of the certain portion of the body of the user 2 detected by the position detection unit 152. The picture generation unit 154 is configured to generate an icon and control the display device 3 in such a manner to display the icon.

In other words, as shown in FIG. 11, the control device 5B includes the storage unit 51, the acquisition unit 53, the first extraction unit 54, the second extraction unit 55, the estimation unit 56, the presentation unit 57B, the position detection unit 152, the marker setting unit 153, the picture generation unit 154, and the estimation unit 155. Besides, when the exercise assisting system 1B is only used as the range-of-motion training system, the first extraction unit 54, the second extraction unit 55, and the estimation unit (posture estimation unit) 56 are optional.

The position detection unit 152 is configured to measure the position of the certain portion of the body of the user 2. In the present embodiment, the position detection unit 152 detects the position of the certain portion of the body of the user 2 in the distance image by user of an image-recognition technique. In this embodiment, an arm of the user 2 is adopted as the certain portion. However, it is sufficient that the certain portion is a specific portion of the body of the user 2 such as a leg and a head. The distance image of the user 2 created by the distance image sensor 4 is a dynamic image which consecutively changes in accordance with the movement of the user 2. The position detection unit 152 can detect in real time the position of the certain portion which successively changes, by means of detecting the position of the certain portion from each frame of the distance image.

In the present embodiment, the position detection unit 152 detects positions of joints of the user 2, and creates a human body model representing the position of the certain portion in a three dimensional space by means of connecting the joints with straight lines. For example, to detect a position of a right arm of the user 2 as the certain portion, the position detection unit 152 detects positions of a joint in a right shoulder, a joint in a right elbow, and a right wrist of the user 2 and then connects these joints with straight lines, thereby creating the human body model corresponding to the right arm of the user 2. With using such a human body model, the position detection unit 152 detects the position of the certain portion of the user 2 in the three dimensional space from an output from the distance image sensor 4 functioning as a three dimensional sensor.

The marker setting unit 153 is configured to decide a position of the marker on the display screen 30 based on the position measured by the position detection unit 152. In the present embodiment, the marker setting unit 153 sets the marker on a position obtained by means of converting the position of at least one of the certain portions from the imaging coordinate system defined in the distance image obtained by the distance image sensor 4 to the display coordinate system defined on the display screen 30. In this embodiment, the display coordinate system is a two dimensional orthogonal coordinate system having coordinate axes respectively corresponding to a left and right direction and an upward and downward direction of the display screen 30 of the display device 3.

In brief, the marker setting unit 153 sets the marker on the position on the display screen 30 obtained by converting the position of at least one of the certain portions from a polar coordinate system based on the distance image sensor 4 to the two dimensional orthogonal coordinate system by use of a predetermined conversion formula. Thus, the marker is set on the position on the display screen 30 corresponding to the position of the certain portion detected by the position detection unit 152.

In the present embodiment, the certain portion is the entire arm but the position on which the marker setting unit 153 sets the marker is the position on the display screen 30 corresponding to the position of the wrist which is a part of the certain portion (arm). However, the marker setting unit 153 may be configured to set the marker on the position of the display screen 30 corresponding to at least a part of the certain portion. The marker setting unit 153 may be configured to set the marker on the position of the display screen 30 corresponding to the entire certain portion.

For example, like the present embodiment, when the certain portion is the entire arm, the marker setting unit 153 may set the marker on the position on the display screen 30 corresponding to the position of the entire arm. In this instance, since the arm as the certain portion has a certain size, the marker is set in such a manner to cover a certain region of the display screen 30.

Additionally, the marker setting unit 153 of the present embodiment has a function of revising the position of the marker such that the marker is set on a position on the display screen 30 overlapped with a particular mirror image corresponding to the certain portion being a part of a mirror image of the user 2 reflected on the half mirror 6. As for the user 2, the position of the mirror image of the user reflected on the half mirror 6 is varied in accordance with a position relation between the half mirror 6 and the user 2. To revise the position of the marker, the marker setting unit 153 gives an appropriate offset to the position obtained by the aforementioned coordinate conversion.

For example, the position of the marker on the display screen 30 is revised in accordance with the position relation between the half mirror 6 and the user 2. It is sufficient that the position relation between the half mirror 6 and the user 2 is preliminarily selected such that the user 2 stands on the center and in front of the half mirror 6. Alternatively, pressure sensors (not shown) for detecting a position of a center of gravity of the user 2 may be added. In this arrangement, the position relation between the half mirror 6 and the user 2 may be calculated from a detection result of the pressure sensors.

Next, an explanation is made to a brief method for revising the position of the marker. The control device 5B includes a height storage unit (not shown) configured to store a predetermined single value (e.g., 170 cm) as the height of the user 2. Besides, the height stored in the height storage unit may be directly inputted by the user 2.

As long as the position relation between the half mirror 6 and the user 2 is determined, the marker setting unit 153 can set the marker on the position overlapped with the certain portion of the mirror image of the user when viewed from the point of view of the user 2 by means of revising the position of the marker as the position based on the height of the user 2.

The following explanation is made to another method. In a situation where the height of the user 2 is not stored in the height storage unit, a position of a particular part (e.g., a head) of the mirror image reflected on the half mirror can be determined based on the position and the direction of the distance image sensor 4, a position on which the user 2 stands, and a position of the top of the head of the user 2. Hence, the marker setting unit 153 can revise the position of the marker as the position superimposed on the certain portion of the mirror image of the user 2 when viewed from the point of view of the user 2.

Besides, the revision of the position of the mark may be performed by manually in the initial setting process or may be performed automatically.

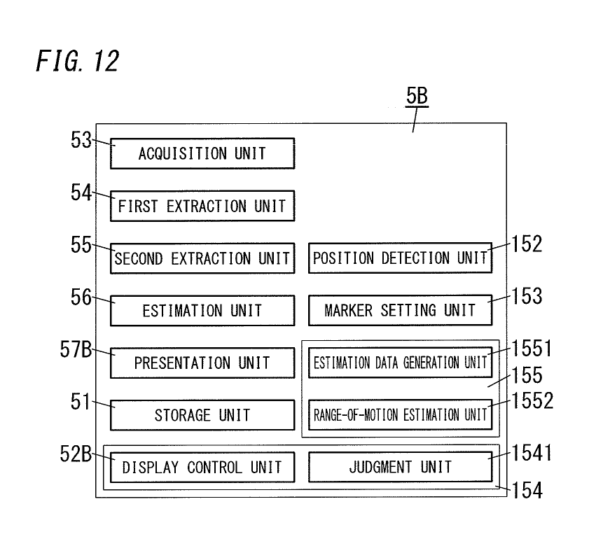

As shown in FIG. 12, the picture generation unit 154 is constituted by a judgment unit 1541 and the display control unit 52B. The judgment unit 1541 is configured to judge whether or not the marker is on a predetermined position on the display screen 30. The display control unit 52B functions as an event image display unit configured to, when the judgment unit 1541 determines that the marker is in the predetermined position, display a predetermined event image at the predetermined position. The picture generation unit 154 creates an icon and controls the display device 3 in such a manner to display the icon. The icon is associated with a predetermined processing. The predetermined processing is performed when the position of the marker set by the marker setting unit 153 is overlapped with the icon. In other words, the picture generation unit 154 controls the display device 3 to display an appropriate icon. Further, the picture generation unit 154 associates the icon with a processing to be performed. Thus, when the position of the marker set by the marker setting unit 153 is overlapped with the icon, the processing associated with the icon can be performed.

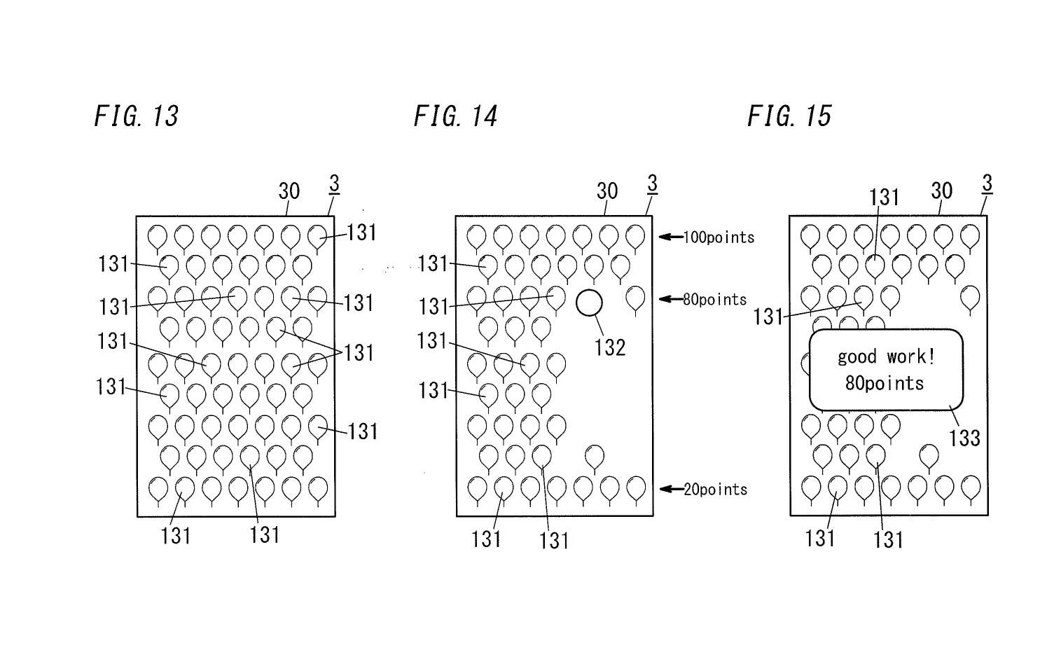

For example, as shown in FIG. 13, the picture generation unit 154 displays a plurality of icons 131 within a predetermined area of the display screen 30 at substantially same intervals. Each icon 131 represents a picture of a balloon. Therefore, the mirror image of the user 2 is reflected on the front face of the half mirror 6 and the icons 131 created by the picture generation unit 154 passes through the half mirror 6 to be reflected on the front face of the half mirror 6.

In this embodiment, the icon 131 is not a still image of a balloon, but is a moving image of a balloon which wobbles like the balloon drifts in the sky. The icon 131 is associated with a processing whereby a graphic of the balloon disappears with an animation representing burst of the balloon when the position of the marker overlaps the graphic of the icon 131. Further, the icon 131 may be associated with a processing whereby a sound corresponding to a change of the graphic, such as a burst sound of a balloon is generated from a speaker (not shown) of the control device 5B when the position of the icon 131 overlaps the graphic of the icon 131. Besides, the icon 131 may be associated with a processing of randomly changing a color of the balloon in a similar manner as iridescent color.

Moreover, it is desirable that the luminance of the display device 3 and the brightness in the room are appropriately adjusted during the usage of the exercise assisting system 1B such that there is no significant difference in the appearance seen from the user 2 between the mirror image reflected on the half mirror 6 and the icon 131 displayed on the display device 3.

In this embodiment, it is sufficient that the position of the marker set by the marker setting unit 153 is used only in an internal processing (a processing of the icon 131) of the control device 5B. Thus, it is not necessary to display the marker itself on the display device 3. However, as shown in FIG. 14, the picture generation unit 154 may control the display device 3 in such a manner to display a mark 132 having an appropriate shape (e.g., a circular shape) on the position where the marker is set. In this arrangement, the user 2 can successfully recognize the position of the marker.

With using the exercise assisting system 1B having the aforementioned configuration, the user 2 can move the marker on the display screen 30 by moving the certain portion (the arm, in this embodiment) while looking at the mirror image of the user reflected on the half mirror 6. When the marker is moved within the display screen 30, the processing showing the burst of the balloon is performed with regard to the icon 131 which overlaps the position of the marker. Thus, the user 2 can visually recognize an area where the certain portion has passed, by looking at the icon 131 displayed on the display screen 30. As for the present embodiment, the certain portion is the arm, and the user 2 can visually recognize a degree of the height of the arm raised by the user.

Hence, the user 2 can perform the range-of-motion training for preventing and remedying limitations on the range of motion of the certain portion of the body (e.g., four limbs), by moving the certain portion while the picture generation unit 154 controls the display device 3 to display the icons 131. The picture generation unit 154 displays the icons 131 on the display device 3 during predetermined training period which is counted by a timer (not shown) in response to performing a predetermined manual operation for starting the range-of-motion training on an input interface (not shown) of the control device 5B. In the present embodiment, it is desirable that the remaining time of the training period is displayed on the display screen 30 of the display device 3 so as to be presented to the user 2.

In the exercise assisting system 1B of the present embodiment, the control device 5B includes an estimation unit (second estimation unit) 155 and the presentation unit 57. The estimation unit 155 is configured to compare an estimation object obtained from a variation of the position of the certain portion with a predetermined estimation criterion and estimate the range of motion of the certain portion. The presentation unit 57 is configured to present an estimation result of the estimation unit 155.

The estimation unit 155 includes an estimation data generation unit 1551 and a range-of-motion estimation unit 1552. The estimation data generation unit 1551 is configured to create estimation data indicative of the range of motion of the certain portion based on the position measured by the position detection unit 152. The range-of-motion estimation unit 1552 is configured to make estimation of the range of motion of the certain portion based on a comparison of the estimation data created by the estimation data generation unit 1551 with criterion data. The estimation unit 155 estimates the range of motion (range of movement) of the certain portion based on the area where the certain portion of the user 2 detected by the position detection unit 152 has actually passed during a period (training period) in which the picture generation unit 154 controls the display device 3 to display the icons 131. In other words, the estimation data includes data indicative the range of movement of the certain portion in a predetermined direction. For example, the icon 131 displayed on the display screen 30 is preliminarily associated with a score. The estimation unit 155 calculates the score corresponding to the icon 131 associated with the processing of bursting the balloon which has performed in response to an event where the position of the marker overlaps the icon. Thus, the estimation unit 155 estimates the score as the range of motion of the arm (certain portion).

In this embodiment, the height at which the user 2 can raise the arm directly relates to the range of motion of the arm. In the estimation, when the height of the arm is higher, the range of motion of the arm is considered to be greater. In the present embodiment, The score is allocated to the icon 131 in accordance with the position of the icon 131 on the display screen 30 such that the icon 131 displayed at the higher position on the display screen 30 is associated with the higher score. The highest score of the acquired scores is adopted as the score of the user 2. In other words, the estimation unit 155 takes the height of the arm from a floor surface as an estimation object, and estimates the range of motion of the arm in the form of the score.

The storage unit 51 of the control device 5B stores allocation of the score to each icon 131. The estimation unit 155 calculates the score of each icon 131 in accordance with the allocation of the score read out from the storage unit 51. In this embodiment, a score of 100 points is selected as a standard score which the healthy person can acquire. The score of 100 points is allocated to the icon 131 displayed on the highest position on the display screen 30, and the score of 20 points is allocated to the icon 131 displayed on the lowest position on the display screen 30. In this embodiment, the storage unit 51 is used as a standard storage unit and stores the allocation of the score to the icon 31 as standard information indicative of a standard of the estimation object (the height of the arm) to be estimated by the estimation unit 155. The estimation unit 155 estimates the range of motion of the arm relative to the standard by comparing the estimation object with the standard information.

The storage unit 51 may store, for example, standard information for each age, sex, and height. In this instance, the estimation unit 155 selects the standard information compared with the estimation object depending on the age, sex, and height of the user 2. Thus, the allocation of the score to the icon 131 is varied depending on the age, sex, and height of the user 2.

The method of estimating the range of movement (range of motion) of the certain portion in a predetermined direction by the estimation unit 155 is not limited to a method of calculating the score in accordance with the height of the certain portion of the user 2 from the floor surface, but may be a method of measuring a moving distance of the certain portion of the user 2 in a certain direction For example, when the certain portion is the arm, the estimation unit 155 may measure a distance in the upward and downward direction from a position (initial position) of an end of the arm which the user 2 puts down to a position of the end of the arm which the user 2 raises up. The estimation unit 155 may adopt the distance as the estimation object. In this instance, when the measured distance is longer, the estimation unit 155 can determine the range of motion of the arm is greater. Therefore, it is sufficient that the higher score is allocated to the icon 131 farther from the initial position. Alternatively, it may be considered that a distance in a horizontal direction (left and right direction) from the center line of the body trunk to an end of the certain portion (e.g., a right arm) is adopted as the estimation object.

In another instance, the estimation unit 155 may be configured to take an area of the region through which the certain portion has passed within a plane (two dimensional space) parallel to the display screen 30 as the estimation object and estimate the range of motion of the certain portion. In other words, the estimation data may include data indicative of the area of the region through which the certain portion has passed within the plane parallel to the display screen 30. For example, the marker setting unit 153 sets the marker on the position within the display screen 30 corresponding to the entire certain portion (arm), and the estimation unit 155 adopts the area of the region through which the marker has passed within the plane parallel to the display screen 30 as the estimation object. In brief, the estimation unit 155 calculates a total score of the icons 131 associated with the processing of bursting the balloon which has performed in response to an event where the position of the marker overlaps the icon, and estimates the range of motion of the certain portion based on the calculated total score. Also in this instance, a score is allocated to each icon 131 such that a score of 100 points is selected as the standard score which the healthy person can acquire. The estimation unit 155 estimates the range of motion of the arm relative to the standard by comparing the estimation object with the standard information.

Alternatively, with regard to the configuration where the position detection unit 152 detects the position of the certain portion in the three dimensional space from an output from the distance image sensor 4 functioning as a three dimensional sensor, the estimation object of the estimation unit 155 may include a volume of a space through which the certain portion has passed in the three dimensional space. In brief, the estimation data may include data indicative of the volume of the space through which the certain portion has passed. In other words, the estimation unit 155 refers to the numerical volume in the three dimensional space, and determines that the range of motion of the arm is greater when the volume is larger. In this instance, the estimation unit 155 converts the volume into points on a 100-point scale based on the standard information stored in the storage unit 51. The estimation unit 155 estimates the range of motion of the certain portion relative to the standard by comparing the evaluation object with the standard information under a condition where a score of 100 points is selected as the standard score which the healthy person can acquire.

Furthermore, as for the estimation unit 155, the estimation object may include time necessary for a predetermined action of the certain portion (e.g., an action in which the certain portion reciprocates in the upward and downward direction once). In other words, the estimation data may include data indicative of the time necessary for the user 2 to perform the predetermined action by the certain portion. For example, an action speed of the certain portion can be calculated by means of dividing the distance from an initial position (e.g., the position of the end of the arm which the user puts down) to a target position (e.g., the position of the end of the arm which the user raises up to the utmost extent) by travel time. The action speed may be used as an index of the degree of recovery. In other words, the estimation unit 155 refers to the time necessary for the predetermined action of the certain portion, and determines that the range of motion of the arm is greater when the time is shorter. In this instance, the estimation unit 155 converts the time into points on a 100-point scale based on the standard information stored in the storage unit 51. The estimation unit 155 estimates the range of motion of the certain portion relative to the standard by comparing the evaluation object with the standard information under a condition where a score of 100 points is selected as the standard score which the healthy person can acquire.

Additionally, as for the estimation unit 155, the evaluation object may include tracks (in a two dimensional space or a three dimensional space) left by travel of the arm adopted as the certain portion. In brief, the estimation data may include data indicative of the tracks of the certain portion. In this instance, the storage unit 51 stores a plurality of standard travel paths of the arm of the healthy person as the standard information. The estimation unit 155 converts a deviation of the evaluation object from the standard information into points on a 100-point scale.

The presentation unit 57B presents the estimation result of the range of motion of the certain portion made by the estimation unit 155 in such a manner as mentioned above, to the user 2. In other words, the presentation unit 57B is configured to present a result of the estimation performed by the estimation unit (range-of-motion estimation unit) 155. For example, the presentation unit 57B informs the user 2 of the estimation result of the estimation unit 56 by use of sound or light. Alternatively, the estimation result of the estimation unit 155 may be displayed by the display device 3 in response to the instructions from the picture generation unit 154. In brief, the display device 3 may be configured to function as the presentation unit 57B. When the display device 3 is used as the presentation unit 57B, as shown in FIG. 15, a message 133 representing the estimation result is displayed on the display screen 30 after a lapse of the training period.

Information presented by the presentation unit 57B may be only the estimation result of the range of motion of the certain portion, or may include a value quantitatively representing the estimation object such as the height (distance), the area, the volume, the time, and the tracks, in addition to the estimation result. For example, when the estimation unit 155 calculates the score depending on the height of the arm of the user 2 from the floor by use of the icon 131 of the balloon as mentioned in the above, the presentation unit 57B may present only the score acquired, or may present a value representing the height of the arm of the user and/or the number of the burst balloons, in addition to the score acquired.

Alternatively, the presentation unit 57B may present the estimation object used in the estimation performed by the estimation unit 155 and the estimation standard (standard information) together, or a deviation between the estimation object and the estimation standard. In this modification, the user 2 can know a standard value of the estimation object and/or a deviation from the standard value in addition to the estimation result, and adopt it as a target of the future range-of-motion training.

As mentioned in the above, the exercise assisting system (range-of-motion training system) 1B of the present embodiment includes the display device 3, the position detection unit 152, the marker setting unit 153, the picture generation unit 154, the estimation unit 155, and the presentation unit 57B. The display device 3 displays a picture on the display screen 30 which is placed in front of the user 2 and faces the user 2. The position detection unit 152 is configured to detect the position of the certain portion of the body of the user 2 which is varied with the motion of the user 2. The marker setting unit 153 is configured to set the marker on the position on the display screen 30 corresponding to the position of at least one part of the certain portion. The picture generation unit 154 is configured to create the icon associated with the predetermined processing, and display the icon on the display device 3. The processing is performed when the position of the marker overlaps the associated icon. The estimation unit 155 is configured to compare the predetermined estimation standard with the estimation object obtained from a variation of the position of the certain portion detected by the position detection unit 152, and estimate the range of motion of the certain portion. The presentation unit 57B presents the estimation result of the estimation unit 155.

In other words, the exercise assisting system 1B includes the position detection unit 152, the marker setting unit 153, the judgment unit 1541, the event image display unit (display control unit) 52B, the estimation data generation unit 1551, and the range-of-motion estimation unit 1552. The position detection unit 152 is configured to measure the position of the certain portion of the body of the user 2. The marker setting unit 153 is configured to decide the position of the marker on the display screen 30 based on the position measured by the position detection unit 152. The judgment unit 1541 is configured to judge whether or not the marker is in a predetermined position on the display screen 30. The event image display unit 52B is configured to, when the judgment unit 1541 determines that the marker is in the predetermined position, display a predetermined event image at the predetermined position. The estimation data generation unit 1551 is configured to create the estimation data indicative of the range of motion of the certain portion based on the position measured by the position detection unit 152. The range-of-motion estimation unit 1552 is configured to make estimation of the range of motion of the certain portion based on a comparison of the estimation data created by the estimation data generation unit 1551 with criterion data. The presentation unit 57B is configured to present a result of the estimation made by the range-of-motion estimation unit 1552.

The exercise assisting system 1B further includes the half mirror 6. The half mirror 6 is disposed on the user 2 side of the display screen 30, and transmits a picture displayed on the display device 3. The marker setting unit 153 is configured to set the marker on the position on the display screen 30 overlapping the mirror image of the certain portion of the mirror image of the user 2 reflected on the half mirror 6. In other words, in the present embodiment, the mirror image displaying means is defined as the half mirror 6 positioned in front of the display device 3. The marker setting unit 153 is configured to decide the position of the marker such that the position of the marker is corresponding to a position in the display screen 30 overlapping the certain portion in the half mirror 6.

Accordingly, the exercise assisting system 1B of the present embodiment as explained above can present the estimation result of the range of motion of the certain portion of the body, to the user 2. Further, according to the exercise assisting system 1B, the estimation unit 155 estimates the range of motion of the certain portion by means of comparing the estimation object calculated based on the variation of the position of the certain portion with the predetermined estimation standard, and then the estimation result is fed back to the user 2 by the presentation unit 57B. Hence, the user 2 can know the measurement result of the range of motion of the certain portion of the user 2, and further understand what is meant by the measurement result. Consequently, for example, the user 2 can know the measurement result representing the height in centimeters of the arm raised up by the user 2, and further know how many points out of 100 points is given to the range of motion. Thus, the user 2 can fully understand the need and effect of the range-of-motion training.

In addition, since as a result of aiming at a high score, the user 2 will move the range of motion of its certain portion without particular consciousness, the user 2 can enjoy sufficient effects of the range-of-motion training by moving the body with a feeling of enjoying games. Besides, in a situation where the arm is adopted as the certain portion, for example, when the user 2 inclines its body trunk, the range of motion of the arm cannot be estimated precisely. Hence, when a portion (e.g., a body trunk) different from the certain portion is moved, a processing of deeming the estimation invalid may be performed.

Moreover, the exercise assisting system 1B includes the standard storage unit 51 configured to store the standard information representing the standard of the evaluation object. The estimation unit 155 is configured to estimate the range of motion with adopting the standard information as the estimation standard. In other words, the standard data is data representing the standard range of motion of the certain portion of the healthy person.

According to the present embodiment, the estimation unit 155 uses the standard information representing the standard of the estimation object and estimates the range of motion based on the comparison between the estimation object and the estimation standard. Hence, the range of motion of the certain portion of the user 2 can be estimated relative to the standard range of motion. Consequently, as for the user 2 whose the range of motion of the certain portion is limited due to a disease or injury, the user 2 can perform the range-of-motion training with aiming for the standard range of motion.

In the exercise assisting system 1B, as for the estimation unit 155, the estimation object includes the area of the region through which the certain portion has passed within a plane parallel to the display screen 30. In other words, the estimation data includes data indicative of the area of the region through which the certain portion has passed within a plane parallel to the display screen 30.

In the exercise assisting system 1B, as for the estimation unit 155, the estimation object includes the range of movement of the certain portion in a predetermined direction. In other words, the estimation data includes data indicative of the range of motion of the certain portion in a predetermined direction.

In brief, when the estimation unit 155 is configured to adopt the ranger of motion of the certain portion in the predetermined direction or the area of the moving region within the plane, as the estimation object, there is no need to three-dimensionally identify the position of the certain portion. In this arrangement, a two dimensional camera such as a CCD (Charge Coupled Device) camera can be used as an alternative to the distance image sensor 4. Thus, there in an advantage in that a processing speed of the position detection unit 152 can be improved. Further, when a single dimensional amount (e.g., a distance) is measured, an object detection sensor using laser or ultrasonic can be adopted as an alternative to the distance image sensor 4.

In the exercise assisting system 1B, the position detection unit 152 detects the position of the certain portion in the three dimensional space from the output from the three dimensional sensor, and the estimation object of the estimation unit 155 includes the volume of the space through which the certain portion has passed in the three dimensional space. In other words, the position detection unit 152 is configured to measure the position of the certain portion based on the output of the three-dimensional sensor. The estimation data includes data indicative of the volume of the space through which the certain portion has passed.

In the exercise assisting system 1B, as for the estimation unit 155, the evaluation object includes tracks left by travel of the certain portion. In other words, the estimation data includes data indicative of tracks of the certain portion.

According to the configuration where the estimation unit 155 takes the volume of the moving space of the certain portion or the moving tracks as the estimation object, the range of motion of the certain portion of the user 2 including a movement in a forward and rearward direction can be estimated in detail.

In the exercise assisting system 1B, as for the estimation unit 155, the estimation object includes the time necessary for the predetermined motion of the certain portion. In other words, the estimation data includes data indicative of time necessary for the user 2 to make the predetermined motion with the certain portion.

According to the configuration where the estimation unit 155 takes, as the estimation object, the time necessary for the predetermined motion of the certain portion, there is an advantage in that the estimation can be made with regard to how smooth the certain portion can move.

In the present embodiment, the storage unit 51 is used as the standard storage unit configured to store the standard (standard information) of the estimation object. The present embodiment is not limited to this configuration, but the storage unit 51 may be used as a history storage unit configured to store a history of the estimation object as history information. In this modification, the history information is defined as information indicating the comparison objects in chronological order for each user 2. The comparison object, such as the height (distance), the area, the volume, the time or the tracks, is obtained based on the variation of the position of the certain portion of the user 2. In other words, the exercise assisting system 1B may include the history storage unit 51 configured to store a history of the estimation object in chronological order as the history information. The estimation unit 155 may take the history information as the estimation standard and estimate the range of motion. In other words, the range-of-motion estimation unit (estimation unit 155) is configured to adopt the estimation data used in the previous estimation of the range of motion of the certain portion as the criterion data.

In this instance, the estimation unit 155 adopts the history information stored in the storage unit 51 as the estimation standard and compares the estimation object with the estimation standard to estimate the range of motion of the certain portion. For example, the estimation unit 155 adopts, as the estimation standard, the comparison object obtained from the previous range-of-motion training performed by the user 2. The estimation unit 155 compares the estimation standard with the comparison object obtained from the current range-of-motion training performed by the user 2, thereby estimating the range of motion of the certain portion. Accordingly, the estimation unit 155 can estimate how the range of motion of the certain portion has changed compared with that in the past on the same user 2. Consequently, it is possible to estimate the degree of progress in the range-of-motion training.

### Fourth Embodiment

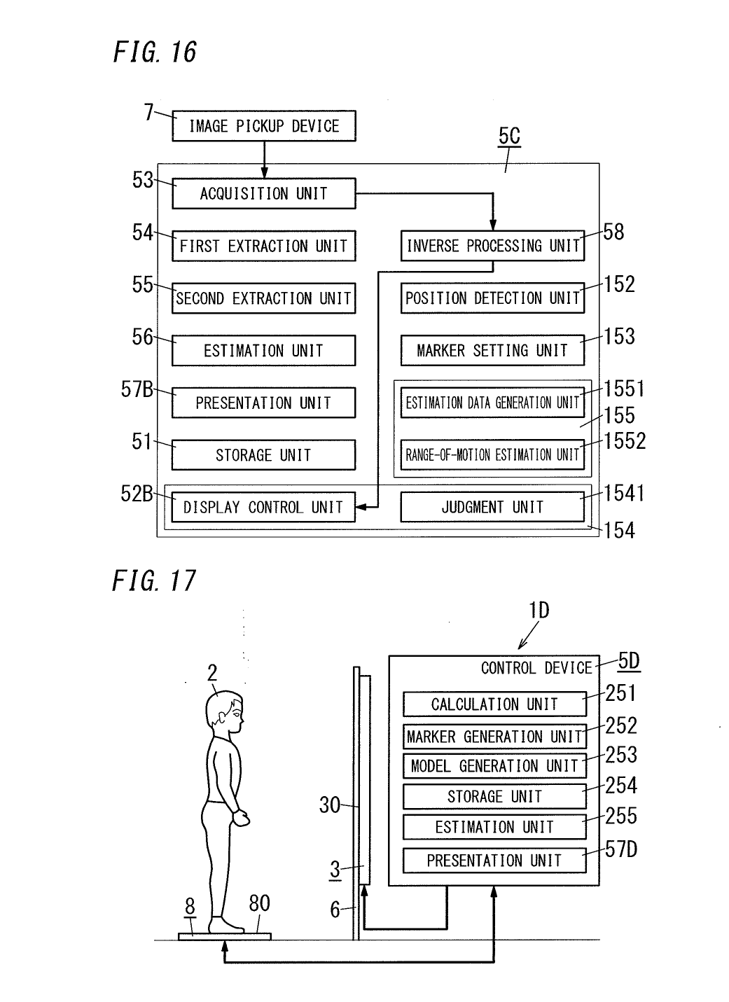

As shown in FIG. 16, the exercise assisting system (range-of-motion training system) 1C of the present embodiment is different from the exercise assisting system (range-of-motion training system) 1B of the third embodiment in that the exercise assisting system 1C lacks the half mirror 6. Further, the exercise assisting system 1C of the present embodiment is provided with the image pickup device 7. The image pickup device 7 is placed in front of the user 2 and has a lens orientated so as to pick up an image of the user 2 from the front.

Further, the exercise assisting system 1C of the present embodiment is different from the exercise assisting system 1B of the third embodiment in the control device 5C. As shown in FIG. 16, the control device 5C includes the inverse processing unit 58 in addition to the storage unit 51, the acquisition unit 53, the first extraction unit (characteristic amount extraction unit) 54, the second extraction unit (criterion amount extraction unit) 55, the estimation unit (posture estimation unit) 56, the presentation unit 57B, the position detection unit 152, the marker setting unit 153, the estimation unit (second estimation unit) 155, and the picture generation unit 154.

The picture generation unit 154 includes the judgment unit 1541 and the display control unit 52B. The display control unit 52B functions as the inverted image display unit configured to display the mirror-reversed image created by the inverse processing unit 58 on the display screen 30.

In the present embodiment, the marker setting unit 153 is configured to decide the position of the marker such that the position of the marker is corresponding to the position of the certain portion in the mirror-reversed image.

That is, the exercise assisting system (range-of-motion training system) 10 of the present embodiment can make the user 2 visually recognize an inverted picture displayed on the display device 3 and cause the user 2 to falsely perceive the inverted picture as a mirror image of its own, without presenting a mirror image which is optically formed.

Further, the picture generation unit 154 controls the display device 3 in such a manner to display the icon 131 together with the inverted picture created by the inverse processing unit 58. The marker setting unit 153 selects the position of the marker such that the position of the marker overlaps the picture of the certain portion of the inverted picture in the display screen 30. In this embodiment, the certain portion is the entire arm. The marker is set on the position corresponding to the position of the wrist as a part of the arm. The marker setting unit 153 sets the marker on the position of the display screen 30 overlapping the picture of the wrist of the arm in the inverted picture.

As mentioned in the above, the exercise assisting system 1C of the present embodiment further includes the image pickup device 7 which is placed in front of the user 2 and is configured to pick up the picture of the user 2. The picture generation unit 154 is configured to control the display device 3 in such a manner to display the icon together with the inverted picture obtained by reversing the picture of the user taken by the image pickup device 7 from left to right. The marker setting unit 153 is configured to set the marker on the position of the display screen 30 overlapping the picture of the certain portion of the inverted picture.

In other words, the mirror image displaying means of the exercise assisting system 1C of the present embodiment is constituted by the image pickup device 7, the inverse processing unit 58, and display control unit (inverted image display unit) 52B. The image pickup device 7 is configured to shoot the user 2 to create the image of the user 2. The inverse processing unit 58 is configured to reverse the image of the user 2 created by the image pickup device 7 from left to right and create the mirror-reversed image. The inverted image display unit 52B is configured to display the mirror-reversed image created by the inverse processing unit 58 on the display screen 30.

According to the exercise assisting system 1C of the present embodiment described above, there is an advantage in that the configuration can be simplified owing to the omission of the half mirror 6 in contrast to the exercise assisting system 1B of the third embodiment. Furthermore, in the configuration of the present embodiment, if a display having a relatively large screen is preinstalled, the existing display can be used as the display device 3 even without newly providing a dedicated display, and therefore it is possible to reduce the introduction cost of the system.

The other configurations and functions of the exercise assisting system 1C of the present embodiment are the same as those of the exercise assisting system 1B of the third embodiment.

### Fifth Embodiment

The exercise assisting system 1D of the present embodiment has an aspect as a center of gravity shifting training system. The center of gravity shifting training system is used for training of center-of-gravity shifting for a user.

While one of important human motor functions is a function of center of gravity shifting, such function of center of gravity shifting may be deteriorated in a patient having a problem with body movement due to a disease or injury, or an elderly person, etc. Since a person who has an inadequate function of center of gravity shifting cannot make a smooth center of gravity shift such that the body weight is applied alternately to the left and right legs, for example, basic motion such as walking may be hindered. Therefore, center of gravity shifting training for enabling smooth center of gravity shifting is widely introduced in, for example, the field of rehabilitation.

By the way, there is proposed a system including a measurement device (balance detection device) disposed at the feet of a user for measuring the proportion of load in the fore and the aft, and the left and the right of the user, in which a picture indicating the center of gravity position of the user which is evaluated from the output of the measurement device is displayed by a display device (for example, see document 3, “JP 2009-277195 A”). Using the system described in document 3 allows a user to learn a correct posture, in which the center of gravity is located at the center, by correcting the posture such that the center of gravity position coincides with the target position.

However, in the system described in document 3, although a training to reduce the fluctuation of the center of gravity position from a correct posture is made possible by a feedback of the center of gravity position to the user, a training of the user to learn a smooth center of gravity shifting needed for walking etc. is difficult. That is, although the system described in document 3 can display the shifting tracks of the center of gravity position, etc., it is difficult to estimate whether or not a smooth center of gravity shifting is performed from shifting tracks of the center of gravity position, and the system is not adequate to be used for the training to learn a smooth center of gravity shifting.

Therefore, it is preferable that the center of gravity shifting training system enables the training to allow a user to learn a smooth center of gravity shifting.

The exercise assisting system 1D of the present embodiment is used as a center of gravity shifting training system. Such a center of gravity shifting training system is used for in rehabilitation targeted for a patient whose center of gravity shifting function has deteriorated due to a disease and injury to enable the patient to perform a smooth center of gravity shifting. The description on the following embodiments, however, is not intended to limit the use of the center of gravity shifting training system, and the center of gravity shifting training system may be used for daily exercises of an able-bodied person and training for learning the feeling of center of gravity shifting necessary for various sports.

As shown in FIG. 17, the exercise assisting system (center of gravity shifting training system) of the present embodiment includes the display device 3, a measurement device 8, and the control device 5D. The display device 3 is configured to reflect a picture on the display screen 30 disposed in front of the user (patient) 2. The measurement device 8 is configured to measure a distribution of a load of the user 2 in a horizontal plane. The control device 5D is configured to control operations of the display device 3 and the like. Each of the display device 3 and the measurement device 8 is connected to the control device 5D. Further, the exercise assisting system 1D of the present embodiment includes the half mirror 6 defining the mirror image displaying means.

The measurement device 8 is disposed on the floor in front of the half mirror 6 and at the feet of the user 2. The measurement device 8 includes a boarding base 80 on which the user 2 boards, and a plurality of load sensors (not shown) for measuring loads acting to the respective left and right legs of the user 2 on the boarding base 80. At least one load sensor is provided to each of a right leg side and a left leg side of the boarding base 80. In other words, the measurement device 8 includes a working surface for receiving a load from the user, and is configured to measure a distribution of the load on the working surface. In the present embodiment, the working surface is defined by an upper surface of the boarding base 80.

In the present embodiment, the measurement device 8 measures the loads by use of the respective load sensors to determine the distribution of the load of the user 2 standing on the boarding base 80 in the horizontal surface. For example, the measurement device 8 measures a load applied to a left region of the boarding base 80 from a center line in a left and right direction of the boarding base 80 and a load applied to a right region of the boarding base 80 from the center line, and determines the distribution of the loads applied to the respective left and right legs in real time.

As mentioned in the above, the measurement device 8 measures the distribution of the load of the user 2 in the horizontal plane in real time, and outputs a measurement result to the control device 5D. It is sufficient that the measurement result of the measurement device 8 outputted to the control device represents a value indicative of the distribution of the load of the user 2 in the horizontal plane. In the present embodiment, the measurement device 8 outputs the measurement result representing the loads respectively applied to the left and right legs of the user 2 to the control device 5D.

Alternatively, the measurement device 8 may be configured to measure the load acting on one of the left and right legs of the user 2 by use of the load sensors. Specifically, when a weight of the user 2 is given to the measurement device 8 as a known parameter, the measurement device 8 may measure the load acting on the left leg. In this situation, the measurement device 8 can determine the distribution of the load of the user 2 from a proportion of the measured load to the weight.

Further, as for the exercise assisting system 1D of the present embodiment, the control device 5D includes a calculation unit 251 configured to calculate a balance value representing a proportion of left and right loads of the user 2 based on the measurement result of the measurement device 8. In addition, the control device 5D includes a marker generation unit 252 and a model generation unit 253, and a storage unit 254. The marker generation unit 252 is configured to generate a marker picture showing a variation of the balance value caused by center of gravity shifting of the user 2. The model generation unit 253 is configured to generate a model picture showing a periodic variation of the balance value corresponding to a model (example) of the center of gravity shifting. The storage unit 254 is configured to store various kinds of setting values therein. The marker generation unit 252 is configured to control the display device 3 in such a manner to display the generated marker picture, and the model generation unit 253 is configured to control the display device 3 in such a manner to display the generated model picture.

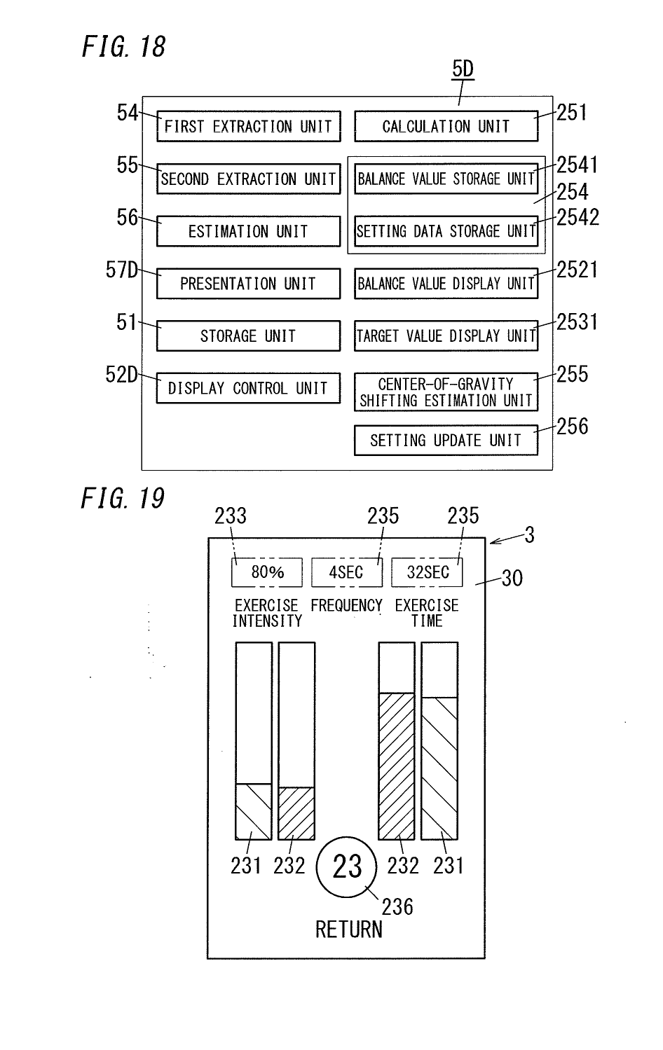

In the present embodiment, as shown in FIG. 18, the control device 5D includes the first extraction unit (characteristic amount extraction unit) 54, the second extraction unit (criterion amount extraction unit) 55, the estimation unit 56, the presentation unit 57D, the storage unit 51, the display control unit 52D, the calculation unit 251, the storage unit (second storage unit) 254, a balance value display unit 2521, a target value display unit 2531, and a center of gravity shifting estimation unit 255. Besides, when the exercise assisting system 1D is only used as the center of gravity shifting training system, the first extraction unit 54, the second extraction unit 55, and the estimation unit (posture estimation unit) 56 are optional.

The calculation unit 251 is configured to calculate the balance value representing the proportion of the load at a prescribed position in the working surface based on the distribution of the load measured by the measurement device 8. For example, the calculation unit 251 calculates in real time the balance value representing the proportion of the load (load acting on the left leg) to the load (load acting on the right leg) from the measurement result. The load acting on the left leg is a load applied to the left region of the boarding base 80 from the center line in the left and right direction of the boarding base 80, and the load acting on the right leg is a load applied to the right region of the boarding base 80 from the center line. Specifically, the calculation unit 251 calculates the balance value in real time based on the loads acting on the respective left and right legs of the user 2, and the balance value is the proportions of the left and right loads to a total of these loads (i.e., the weight of the user 2) defining a standard.

The second storage unit 254 includes a balance value storage unit 2541 and a setting data storage unit 2542. The balance value storage unit 2541 is configured to store the balance value calculated by the calculation unit 251. The setting data storage unit 2542 is configured to store setting data representing a time variation of a target value of the balance value. For example, the setting data is defined as data representing a sinusoidal wave with a predetermined period. The setting data includes a period and an amplitude value as parameters defining the sinusoidal wave. Further, the setting data includes exercise time defining a length of the sinusoidal wave. In the present embodiment, the amplitude value is represented by an exercise intensity. The exercise intensity indicates a proportion (percentage) of the amplitude value to a predetermined criterion value. For example, when the exercise intensity is 50%, the amplitude value is half of the criterion value.

For example, the weight of the user 2 is 50 kg, and the load acting on the left leg is 30 kg, and the load acting on the right leg is 20 kg. The calculation unit 251 calculates the balance value indicating that the proportion of the load acting on the left leg is 60% (=0.6) and the proportion of the load acting on the right leg is 40% (=0.4). Besides, the total of the proportion of the load acting on the left leg and the proportion of the load acting on the right leg is always 100% (=1).

The marker generation unit 252 generates the marker picture based on the balance value calculated by the calculation unit 251, and controls the display device 3 to display the marker picture. In the present embodiment, the marker generation unit 252 is constituted by the balance value display unit 2521 and the display control unit 52D. The balance value display unit 2521 is configured to display the balance value calculated by the calculation unit 251 on the display screen 30. In the present embodiment, the balance value display unit 2521 generates the marker picture (marker image) based on the balance value, and then controls the display control unit 52D such that the marker picture is displayed on the display screen 30.

Meanwhile, the model generation unit 253 generates the model picture in accordance with the setting value stored in the storage unit 254, and controls the display device 3 to display the model picture. In the present embodiment, the model generation unit 253 is constituted by the target value display unit 2531 and the display control unit 52D. The target value display unit 2531 is configured to display the target value on the display screen 30 based on the setting data stored in the setting data storage unit 2542. In the present embodiment, the target value display unit 2521 generates the model picture (model image) based on the target value (setting value), and then controls the display control unit 52D such that the model picture is displayed on the display screen 30.

Each of the marker picture and the model picture is a moving picture representing the balance value in real time. In the present embodiment, as shown in FIG. 19, each of the marker picture and the model picture is a picture showing bar charts having heights respectively proportional to the proportion of the load acting on the left leg and the proportion of the load action on the right leg. As to the instance shown in FIG. 19, the four bar charts are arranged in the left and right direction on the display screen 30. The outside two bar charts of the four bar charts are corresponding to the marker picture 231, and the inside two bar charts of the four bar charts are corresponding to the model picture 232. For example, to enable the user 2 to easily distinguish between the marker picture 231 and the model picture 232, the bar charts of the marker picture 231 are represented in white, and the bar charts of the model picture 232 are represented in orange.

In other words, each of the marker picture 231 and the model picture 232 includes the pair of the bar charts respectively corresponding to the left and right legs. As for each of the marker picture 231 and the model picture 232, the proportion of each of the loads acting on the left and right legs to the total body weight is represented by the height of the bar chart displayed within a vertically long rectangular frame while the maximum of the proportion is 100%. In the present embodiment, the bar charts displayed on the left end of the display screen 30 are associated with the left leg, and the bar charts displayed on the right end of the display screen 30 are associated with the right leg. Each of the marker picture 231 and the model picture 232 reflects the proportion of each of the loads acting on the left and right legs on the height of the bar shown by the bar chart in units of 1%.

Consequently, for example, the user 2 performs center of gravity shifting such that the center of gravity is shifted from the left leg to the right leg. In this situation, with regard to the marker picture 231, in accordance with the center of gravity shifting, the height of the bar shown by the bar chart associated with the left leg is gradually decreased and the height of the bar shown by the bar chart associated with the right leg is gradually increased. In contrast, as for the model picture 232, one of the bars of the left and right bar charts becomes higher or lower than the other alternately, irrespective of the movement of the user 2. Hence, the model picture 232 shows a periodic variation of the balance value defining the model of the center of gravity shifting of the user 2.

The storage unit 254 (setting data storage unit 2542) preliminarily stores the period, the exercise intensity, and the exercise time as the setting values defining the movement in the model picture 232. In this regard, the period defines a period of a variation of the balance value, and the exercise intensity defines the maximum (i.e., the maximum of the bar chart) of the proportion of the load acting on each of the left and right legs, and the exercise time defines time during which the user 2 exercise. These setting values are arbitrarily set by use of the input interface (e.g., a keyboard) used as the input unit of the control device 5D from the outside, and are preliminarily stored in the storage unit 254. Besides, the exercise intensities of the respective left and right legs may be set to different values.

The model generation unit 253 generates the model picture 232 representing a pattern of a variation of the balance value defined by the period and the exercise intensity stored in the storage unit 254, and controls the display device 3 in such a manner to display the model picture 232 for the exercise time. In the present embodiment, the model generation unit 253 generates the model picture 232 in which the height of the bar shown by the bar chart is varied such that a time variation of the height of the bar is a sinusoidal wave.

Besides, the instance shown in FIG. 19, each of the exercise intensity 233, the period (frequency) 234, and the exercise time 235 is displayed on an upper side of the marker picture 231 and the model picture 232 on the display screen 30, and remaining time 236 is displayed on a lower side of the marker picture 231 and the model picture 232. With this regard, the remaining time indicates time obtained by subtracting elapsed time from the exercise time. With displaying such information, the user 2 can quantitatively recognize a pattern of the exercise represented by the variation of the bar of the bar chart in the model picture 232.

As mentioned in the above, the marker picture 231 and the model picture 232 are displayed on the display device 3. Hence, the user 2 can perform the center of gravity shifting of varying the proportion of the load acting to each of the left and right legs, such that the marker picture 231 follows the movement of the bar in the bar chart of the marker picture 231. In other words, the user 2 can perform the center of gravity shifting so as to vary the proportion of the load acting to each of the left and right legs in accordance with the movement of the bar in the bar chart of the model picture 232. In this regard, when an event where the balance value calculated by the calculation unit 251 falls within a predetermined allowable range (e.g., ±3%) centered on the balance value indicated by the model picture 232 occurs, the model generation unit 253 may notify the user 2 of occurrence of the event by changing the display color of the bar chart, for example.

Additionally, in the exercise assisting system 1D of the present embodiment, the control device 5D includes the estimation unit (center of gravity shifting estimation unit) 255 and the presentation unit 57D. The estimation unit 255 is configured to estimate a deviation of timing of a change in the balance value between the model picture 232 and the marker picture 231. The presentation unit 57D is configured to present an estimation result of the estimation unit 255.

The center of gravity shifting estimation unit 255 is configured to calculate the time variation of the balance value from the balance value stored in the balance value storage unit 2541 and make the estimation of the center of gravity shifting of the user 2 based on the time variation of the balance value and the time variation of the target value indicated by the setting data. In other words, the estimation unit (center of gravity shifting estimation unit) 255 compares the marker picture 231 representing the variation of the balance value caused by the center of gravity shifting of the user 2 with the model picture 232 representing the periodic variation of the balance value defining the model of the center of gravity shifting, and estimates the deviation of the timing of the change in the balance value between these pictures. This estimation result shows a following performance of the actual center of gravity shifting of the user 2 represented by the marker picture 231 relative to the model center of gravity shifting represented by the model picture 232. The lower deviation indicates the higher following performance.

In more detailed explanations, the center of gravity shifting estimation unit 255 calculates a difference between the value indicated by the model picture 232 and the value indicated by the marker picture 231 with regard to the proportion of the load acting on one of the legs (e.g., the right leg) to the total body weight at a predetermined sampling period (e.g., 100 msec). The difference calculated in such a manner is preliminarily associated with a score corresponding to a magnitude of the difference. Each time the difference is calculated, the center of gravity shifting estimation unit 255 adds the score corresponding to the calculated difference, and adopts a total score eventually calculated as an estimation score. With regard to the estimation score calculated in such a manner, the scores are allocated to the differences such that the higher score is allocated to the lower difference (i.e., the lower deviation).

In brief, in the present embodiment, as for the center of gravity shifting estimation unit 255, the estimation object includes a difference between the balance values of the model picture 232 and the marker picture 231 at the same timing. The center of gravity shifting estimation unit 255 estimates the deviation between the model picture 232 and the marker picture 231. In brief, the center of gravity shifting estimation unit 255 is configured to perform the estimation of the center of gravity shifting by use of a difference between the balance value and the target value at a predetermined point of time. Accordingly, for example, when the balance values of the model picture 232 and the marker picture 231 are varied at the same timing but the balance values of the model picture 232 and the marker picture 231 have different magnitudes, the estimation unit 255 can estimate a deviation between the magnitudes of the balance values. Consequently, there is an advantage in that the estimation unit 255 can strictly estimate the deviation between the actual center of gravity shifting of the user 2 represented by the marker picture 231 and the model center of gravity shifting represented by the model picture 232.

Besides, the estimation method performed by the center of gravity shifting estimation unit 255 is not limited to the aforementioned method. It is sufficient that the estimation method is a method enabling the estimation unit 255 to estimate the deviation of the timing of the change in the balance value between the model picture 232 and the marker picture 231. For example, the center of gravity shifting estimation unit 255 may calculate the difference each time a predetermined period elapses. Thereafter, the center of gravity shifting estimation unit 255 may calculate a total of the calculated differences and calculate the estimation score by means of converting the calculated total into a score.

Even when the estimation object does not include the difference between the balance values at the same timing, the estimation unit 255 can estimate the deviation of the timing of change in the balance value between the model picture 232 and the marker picture 231. For example, the estimation unit 255 may detect a local maximum point (or local minimum point) of the proportion of the load acting on one of the legs (e.g., the right leg) to the total body weight with regard to each of the model picture 232 and the marker picture 231, and perform the estimation of numerically determining a deviation between the local maximum points (or the local minimum points) in a time axis direction.

The presentation unit 57D is configured to present the result of the estimation made by the center of gravity shifting estimation unit 255. For example, the presentation unit 57D presents the estimation result of the deviation of the timing between the model picture 232 and the marker picture 231 made by the center of gravity shifting estimation unit 255, to the user 2. Specifically, the presentation unit 57D presents the estimation result of the center of gravity shifting estimation unit 255 to the user 2 by use of sound or light. Alternatively, the estimation result of the center of gravity shifting estimation unit 255 may be displayed by the display device 3. In brief, the display device 3 may be configured to function as the presentation unit 57D. When the display device 3 is used as the presentation unit 57D, it is conceivable that a message representing the estimation result is displayed on the display screen 30 after the end of the training period.

The information presented by the presentation unit 57D may be the estimation score quantitatively represents a degree of the deviation obtained by numerically determining the degree of the deviation, or a result obtained by ranking the estimation score into plural levels. When the estimation unit 255 judges a tendency of the deviation which shows that the balance value is greatly deviated when the user intends to move the center of gravity to the right leg side, the presentation unit 57D may present an advice corresponding to the judgment result.

The following explanation is made to an instance where the user 2 performs the center of gravity shifting training by use of the aforementioned exercise assisting system (center of gravity training system) 1D.

When a predetermined operation to start the training on the input interface is performed, the control device 5D starts to count the exercise time by use of a timer (not shown) and controls the display device 3 to display the marker picture 231 and the model picture 232. The user 2 can perform the center of gravity shifting such that the movement of the marker picture 231 coincides with the model picture 232, while viewing the marker picture 231 and the model picture 232. Hence, the user 2 can perform a proper exercise of the center of gravity shifting.

When the exercise time elapses, the control device 5D ends displaying the marker picture 231 and the model picture 232, and estimates the deviation of the timing between the model picture 232 and the marker picture 231 by the center of gravity shifting estimation unit 255, and present the estimation result to the user 2 by the presentation unit 57D. In this situation, when the predetermined operation to start the training on the input interface is performed, the control device 5D counts the exercise time again and controls the display device 3 to display the marker picture 231 and the model picture 232.

As mentioned in the above, the exercise assisting system (center of gravity shifting training system) 1D of the present embodiment includes the display device 3, the control device 5D, and the measurement device 8. The display device 3 is configured to reflect a picture on the display screen 30. The control device 5D is configured to control the display device 3 in such a manner to display an image. The measurement device 8 is placed at the feet of the user 2 facing the display screen 30, and is configured to measure the distribution of the load of the user 2 in the horizontal plane. The control device 5D includes the calculation unit 251, the marker generation unit 252, the model generation unit 253, the center of gravity shifting estimation unit 255, and the presentation unit 57D. The calculation unit 251 is configured to calculate the balance value representing the proportion of the load in the left and the right or the fore and the aft of the user 2 based on the measurement result of the measurement device 8. The marker generation unit 252 is configured to generate the marker picture representing the variation of the balance value depending on the center of gravity shifting of the user 2, and controls the display device 3 to display the marker picture. The model generation unit 253 is configured to generate the model picture representing the periodic variation of the balance value defining the model of the center of gravity shifting, and controls the display device 3 to display the model picture. The center of gravity shifting estimation unit 255 is configured to estimate the deviation of the timing of the change in the balance value between the model picture and the marker picture. The presentation unit 57D is configured to present the estimation result of the estimation unit 255.

In other words, the exercise assisting system 1D includes the measurement device 8, the calculation unit 251, the balance value storage unit 2541, the balance value display unit 2521, the setting data storage unit 2542, the target value display unit 2531, and the center of gravity shifting estimation unit 255. The measurement device 8 has the working surface (the upper surface of the boarding base 80) for receiving the load from the user 2 and is configured to measure the distribution of the load in the working surface. The calculation unit 251 is configured to calculate the balance value representing the proportion of the load at the prescribed position in the working surface based on the distribution of the load measured by the measurement device 8. The balance value storage unit 2541 is configured to store the balance value calculated by the calculation unit 251. The balance value display unit 2521 is configured to display the balance value calculated by the calculation unit 251 on the display screen 30. The setting data storage unit 2542 is configured to store the setting data indicative of the time variation of the target value for the balance value. The target value display unit 2531 is configured to display the target value on the display screen 30 based on the setting data stored in the setting data storage unit 2542. The center of gravity shifting estimation unit 255 is configured to calculate the time variation of the balance value from the balance value stored in the balance value storage unit 2541 and make the estimation of the center of gravity shifting of the user 2 based on the time variation of the balance value and the time variation of the target value indicated by the setting data. The presentation unit 57D is configured to present the result of the estimation made by the center of gravity shifting estimation unit 255.

According to the center of gravity training system 1D with the aforementioned configuration, the user 2 can learn the proper center of gravity shifting represented by the model picture 232 by performing the center of gravity shifting such that the marker picture 231 coincides with the model picture 232. Especially, by training such that the user 2 can perform the center of gravity shifting in accordance with the position of the center of gravity which varies periodically, the user 2 can learn how to smoothly shift the center of gravity. Hence, the user 2 can train to learn the smooth shifting of the center of gravity necessary for walking, by moving the body with a feeling of enjoying games, for example. Accordingly, the exercise assisting system 1D of the present embodiment can have the user 2 train to learn the smooth shifting of the center of gravity. By performing such training, the user 2 can also train an instantaneous force and such training serves to prevent the user 2 from falling in walking.

In the exercise assisting system 1D, as for the estimation unit 255, the estimation object includes the difference between the balance values of the model picture and the marker picture at the same timing. In other words, the estimation unit (center of gravity shifting estimation unit) 255 is configured to make the estimation of the center of gravity shifting by use of the difference between the balance value and the target value at the predetermined time point.

Therefore, according to the exercise assisting system 1D of the present embodiment, the estimation unit 255 refers to the deviation of the timing between the model picture 232 and the marker picture 231, and estimates the following performance of the actual center of gravity shifting of the user relative to the model center of gravity shifting represented by the model picture 232. The estimation result is fed back to the user 2 via the presentation unit 57D. Hence, based on the estimation result of whether or not the user 2 can smoothly move the center of gravity, the user 2 can fully understand the need and effect of the center of gravity shifting training.

The exercise assisting system 1D of the present embodiment further includes the half mirror 6. The half mirror 6 is placed on the user 2 side of the display screen 30. The half mirror 6 transmits a picture displayed on the display device 3 and reflects a mirror image of the user 2. In other words, the exercise assisting system 1D of the present embodiment includes the half mirror 6 placed in front of the display screen 30 as the mirror image displaying means.

According to the exercise assisting system 1D of the present embodiment, since the user 2 can move while viewing its own mirror image reflected on the half mirror 6, the user 2 can visually learn how its center of gravity is shifted depending on various postures that it adopts. For that reason, there is an advantage in that the user 2 can learn its body movement necessary for center of gravity shifting, such as how to lean its body when, for example, applying load on the right leg, while performing training. Further, the user 2 can visually understand the center of gravity shifting as well as can perform training of the center of gravity shifting while confirming the posture of its own. For example, the user 2 can perform training to shift the center of gravity while confirming the inclination of its body. Additionally, the user 2 can perform training to shift its center of gravity while keeping the line connecting both the shoulders horizontal.

Further, in the exercise assisting system (center of gravity training system) 1D of the present embodiment, the control device 5D includes the storage unit (setting data storage unit) 2542 and the setting update unit 256. The storage unit 2542 is configured to store the setting value for defining the movement of the model picture. The setting update unit 256 is configured to modify the setting value stored in the storage unit 2542 in accordance with the estimation result of the estimation unit 255. In other words, the control device 5D includes the setting update unit 256 configured to modify the time variation of the target value indicated by the setting data stored in the setting data storage unit 2542 in accordance with the result of the estimation made by the center of gravity shifting estimation unit 255.

According to this configuration, the model generation unit 253 varies the content of the model picture 232 in accordance with the estimation result of the estimation unit 255.

For example, when a high estimate is obtained by the estimation unit 225 (when the deviation is low), the setting update unit 256 shortens the period of the setting value or raises the exercise intensity in order to increase a level of the difficulty of the center of gravity shifting represented by the model picture 232. For example, when the deviation is not greater than a first threshold value, the setting update unit 256 shortens the period by a predetermined value, or raises the exercise intensity by a predetermined value. In contrast, when a low estimate is obtained by the estimation unit 225 (when the deviation is high), the setting update unit 256 prolongs the period of the setting value or lowers the exercise intensity in order to decrease the level of the difficulty of the center of gravity shifting represented by the model picture 232. For example, when the deviation is not less than a second threshold value exceeding the first threshold value, the setting update unit 256 prolongs the period by a predetermined value, or lowers the exercise intensity by a predetermined value.

Consequently, the exercise assisting system (center of gravity sifting training system) 1D has an advantage that it can have the user 2 perform training with difficulty in accordance with the ability of the center of gravity shifting of the user 2. Hence, the exercise assisting system 1D can have the user 2 perform an appropriate exercise with avoiding the user 2 from being subjected to an excessive load.

Besides, the present embodiment relates to an instance where a picture of a bar chart is adopted as each of the marker picture 231 and the model picture 232. However, the present embodiment is not limited to this instance. For example, the marker picture 231 and the model picture 232 may be a picture representing a needle which swings left and right from a base position in which the needle is directed in an upward direction.

### Sixth Embodiment

The exercise assisting system (center of gravity shifting training system) 1E of the present embodiment is different from the exercise assisting system (center of gravity shifting training system) 1D of the fifth embodiment in that the exercise assisting system 1E lacks the half mirror 6. Further, the exercise assisting system 1E of the present embodiment is provided with the image pickup device 7. The image pickup device 7 is placed in front of the user 2 and has a lens orientated so as to pick up an image of the user 2 from the front.

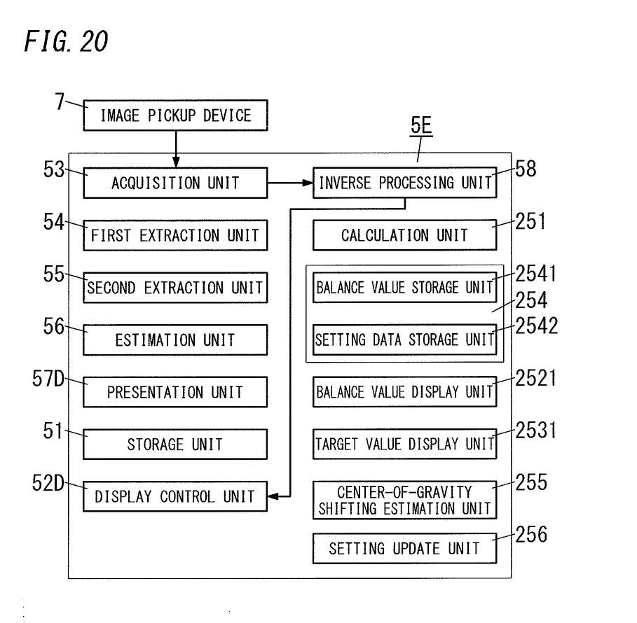

Further, the exercise assisting system 1E of the present embodiment is different from the exercise assisting system 1D of the fifth embodiment in the control device 5E. As shown in FIG. 20, the control device 5E includes the acquisition unit 53 and the inverse processing unit 58 in addition to the first extraction unit (characteristic amount extraction unit) 54, the second extraction unit (criterion amount extraction unit) 55, the estimation unit 56, the presentation unit 57D, the storage unit 51, the display control unit 52D, the calculation unit 251, the storage unit (second storage unit) 254, the balance value display unit 2521, the target value display unit 2531, and the center of gravity shifting estimation unit 255.

The display control unit 52D functions as the inverted image display unit configured to display the mirror-reversed image created by the inverse processing unit 58 on the display screen 30.

That is, the exercise assisting system 1E of the present embodiment can make the user 2 visually recognize an inverted picture displayed on the display device 3 and cause the user 2 to falsely perceive the inverted picture as a mirror image of its own, without presenting a mirror image which is optically formed. Consequently, the exercise assisting system 1E of the present embodiment can produce the same effect as that of the configuration provided with the half mirror 6.

Further, the marker generation unit 252 and the model generation unit 253 controls the display device 3 in such a manner to display the marker picture 231 and the model picture 232 together with the inverted picture created by the inverse processing unit 58. The inverted picture may be displayed overlapping the marker picture 231 and the model picture 232. In this instance, preferably, the inverted picture is displayed as a semi-transparent picture (having, for example, a transmissivity of 50%).

As mentioned in the above, the mirror image displaying means of the exercise assisting system 1E of the present embodiment is constituted by the image pickup device 7, the inverse processing unit 58, and display control unit 52D. The image pickup device 7 is configured to shoot the user 2 to create the image of the user 2. The inverse processing unit 58 is configured to reverse the image of the user 2 created by the image pickup device 7 from left to right and create the mirror-reversed image. The display control unit 52D is configured to display the mirror-reversed image created by the inverse processing unit 58 on the display screen 30.

According to the exercise assisting system 1E of the present embodiment described above, there is an advantage in that the configuration can be simplified owing to the omission of the half mirror 6 in contrast to the exercise assisting system 1D of the fifth embodiment. Furthermore, in the configuration of the present embodiment, if a display having a relatively large screen is preinstalled, the existing display can be used as the display device 3 even without newly providing a dedicated display, and therefore it is possible to reduce the introduction cost of the system.

Besides, since the marker picture 231 presents the center of gravity shifting of the user 2 to the user 2, it is not necessary that the user 2 can exercise with looking at its own picture (mirror image). Hence, it is possible to omit a function of displaying the inverted picture.

The other configurations and functions of the exercise assisting system 1E of the present embodiment are the same as those of the exercise assisting system 1 of the fifth embodiment.

The fifth and sixth embodiments relate to an instance where the calculation unit 251 calculates the proportion of the left and right loads of the user 2 as the balance value and the estimation unit 255 estimates the deviation of the center of gravity shifting based on the balance value, but are not limited to this instance. In a modification, the balance value may be a proportion of front and rear loads of the user 2. In this modification, the exercise assisting system (center of gravity shifting training system) 1E can be applied to training of performing the center of gravity shifting of moving the center of gravity forward and backward alternately.

1. An exercise assisting system comprising:
a display device including a display screen for displaying an image to a user;
a comparison image storage unit configured to store a comparison image defined as an image of an exerciser performing a predetermined exercise;
a comparison image display unit configured to display the comparison image stored in said comparison image storage unit on said display screen;
a mirror image displaying means configured to display a mirror image of the user such that the mirror image is superimposed onto the comparison image;
a characteristic amount extraction unit configured to detect a position of predetermined one or more sampling points of a body of the user and calculate a characteristic amount representing a posture of the user based on the position of the one or more sampling points;
a posture estimation unit configured to compare the characteristic amount calculated by said characteristic amount extraction unit with a criterion amount representing a posture of the exerciser and perform estimation of a deviation between the posture of the user and the posture of the exerciser; and
a presentation unit configured to give a result of the estimation performed by said posture estimation unit.

2. An exercise assisting system as set forth in claim 1, wherein
said mirror image displaying means is a half mirror placed in front of said display device.

3. An exercise assisting system as set forth in claim 1, wherein
said mirror image displaying means comprises:
an image pickup device configured to shoot the user to create an image of the user;
an inverse processing unit configured to reverse the image of the user created by said image pickup device from left to right and create a mirror-reversed image; and
an inverted image display unit configured to display the mirror-reversed image created by said inverse processing unit.

4. An exercise assisting system as set forth in claim 1, wherein
the predetermined exercise is a model of an exercise performed by the user.

5. An exercise assisting system as set forth in claim 1, wherein
said exercise assisting system further comprises:
an image pickup device configured to shoot the user performing the predetermined exercise and create a recorded image defined as an image of the user performing the predetermined exercise; and
a criterion amount extraction unit,
wherein said comparison image display unit is configured to display, on said display screen, the recorded image created by said image pickup device as the comparison image, and
said criterion amount extraction unit is configured to detect the position of the predetermined one or more sampling points of the body of the user from the recorded image and calculate the characteristic amount representing the posture of the user based on the position of the one or more sampling points, as the criterion amount.

6. An exercise assisting system as set forth in claim 1, wherein
said characteristic amount extraction unit is configured to detect the positions of the respective plural sampling points of the body of the user and create a human body model representing the body of the user based on the positions of the respective plural sampling points and calculate the characteristic amount based on the human body model.

7. An exercise assisting system as set forth in claim 6, wherein
the characteristic amount is defined as an angle between a predetermined criterion line and a straight line connecting the two sampling points selected from the plural sampling points.

8. An exercise assisting system as set forth in claim 1, wherein
the characteristic amount is defined as an inclination of the body of the user.

9. An exercise assisting system as set forth in claim 8, wherein
the inclination of the body of the user is defined as an inclination of a shoulder of the user, and
said characteristic amount extraction unit is configured to detect the positions of the sampling points of right and left upper limbs of the user, and calculate an angle between a horizontal line and a straight line connecting the sampling points of the right and left upper limbs, as the inclination of the shoulder of the user.

10. An exercise assisting system as set forth in claim 8, wherein
the inclination of the body of the user is defined as an inclination of a body trunk of the user, and
said characteristic amount extraction unit is configured to detect the positions of the sampling points of a head and a lower back of the user, and calculate an angle between a vertical line and a straight line connecting the sampling points of the head and the lower back, as the inclination of the body trunk of the user.

11-29. (canceled)

30. An exercise assisting system as set forth in claim 1, wherein
the characteristic amount represents a range of motion of a certain portion of the body of the user.

31. An exercise assisting system as set forth in claim 30, wherein
the certain portion is an upper limb of the user, and
said characteristic amount extraction unit is configured to detect the positions of the sampling points of the upper limb and a shoulder connected to the upper limb of the user and calculate an angle between a vertical line and a straight line connecting the sampling points of the upper limb and the shoulder as the range of motion of the upper limb.

32. An exercise assisting system as set forth in claim 6, wherein
the number of the sampling points is three or more, and
the characteristic amount is an area of a closed region defined by the sampling points.

33. An exercise assisting system as set forth claim 1, wherein
said comparison image display unit is configured to adjust at least one of a position and a size of the comparison image on the display screen such that the comparison image is superimposed on the mirror image of the user.

34. An exercise assisting system as set forth in claim 1, wherein
said posture estimation unit is configured to calculate a numerical value indicative of a difference between the characteristic amount and the criterion amount, and
said presentation unit is configured to present the numerical value calculated by said posture estimation unit.

35. An exercise assisting system as set forth in claim 1, wherein
said exercise assisting system further comprises:
a position detection unit configured to measure a position of a certain portion of the body of the user;
a marker setting unit configured to decide a position of a marker on said display screen based on the position measured by said position detection unit;
a judgment unit configured to judge whether or not the marker is in a predetermined position on said display screen;
an event image display unit configured to, when said judgment unit determines that the marker is in the predetermined position, display a predetermined event image at the predetermined position;
an estimation data generation unit configured to create estimation data indicative of a range of motion of the certain portion based on the position measured by said position detection unit; and
a range-of-motion estimation unit configured to make estimation of the range of motion of the certain portion based on a comparison of the estimation data created by said estimation data generation unit with criterion data, and
said presentation unit is configured to present a result of the estimation made by said range-of-motion estimation unit.

36. An exercise assisting system as set forth in claim 35, wherein
said range-of-motion estimation unit is configured to adopt the estimation data used in the previous estimation of the range of motion of the certain portion as the criterion data.

37. An exercise assisting system as set forth in claim 35, wherein
the criterion data is defined as data indicative of a standard range of motion of the certain portion of a healthy person.

38. An exercise assisting system as set forth in claim 35, wherein
the estimation data includes data indicative of an area of a region through which the certain portion has passed within a plane parallel to said display screen.

39. An exercise assisting system as set forth in claim 35, wherein
the estimation data includes data indicative of a range of motion of the certain portion in a predetermined direction.

40. An exercise assisting system as set forth in claim 35, wherein
the estimation data includes data indicative of time necessary for the user to make a predetermined motion with the certain portion.

41. An exercise assisting system as set forth in claim 35, wherein
said position detection unit is configured to measure a position of the certain portion based on an output of a three-dimensional sensor; and
the estimation data includes data indicative of a volume of a space through which the certain portion has passed.

42. An exercise assisting system as set forth in claim 35, wherein
the estimation data includes data indicative of tracks of the certain portion.

43. An exercise assisting system as set forth in claim 35, wherein
said mirror image displaying means is defined as a half mirror positioned in front of said display device, and
said marker setting unit is configured to decide the position of the marker such that the position of the marker is corresponding to a position in said display screen overlapping the certain portion in said half mirror.

44. An exercise assisting system as set forth in claim 35, wherein
said mirror image displaying means comprises:
an image pickup device configured to shoot the user and create an image of the user;
an inverse processing unit configured to reverse the image of the user created by said image pickup device from left to right and create a mirror-reversed image; and
an inverted image display unit configured to display the mirror-reversed image created by said inverse processing unit,
said marker setting unit is configured to decide the position of the marker such that the position of the marker is corresponding to the position of the certain portion in the mirror-reversed image.

45. An exercise assisting system as set forth in claim 1, wherein
said exercise assisting system further comprises:
a measurement device having a working surface for receiving a load from the user and configured to measure a distribution of the load in said working surface;
a calculation unit configured to calculate a balance value representing a proportion of the load at a prescribed position in said working surface based on the distribution of the load measured by said measurement device;
a balance value storage unit configured to store the balance value calculated by said calculation unit;
a balance value display unit configured to display the balance value calculated by said calculation unit on said display screen;
a setting data storage unit configured to store setting data indicative of a time variation of a target value for the balance value;
a target value display unit configured to display the target value on said display screen based on the setting data stored in said setting data storage unit; and
a center of gravity shifting estimation unit configured to calculate a time variation of the balance value from the balance value stored in said balance value storage unit and make estimation of a center of gravity shifting of the user based on the time variation of the balance value and the time variation of the target value indicated by the setting data, and
said presentation unit is configured to present a result of the estimation made by said center of gravity shifting estimation unit.

46. An exercise assisting system as set forth in claim 45, wherein
said center of gravity shifting estimation unit is configured to make the estimation of the center of gravity shifting by use of a difference between the balance value and the target value at a predetermined time point.

47. An exercise assisting system as set forth in claim 45, wherein
said exercise assisting system further comprises a setting update unit configured to modify the time variation of the target value indicated by the setting data stored in said setting data storage unit in accordance with the result of the estimation made by said center of gravity shifting estimation unit.

48. An exercise assisting system as set forth in claim 45, wherein
said mirror image display unit is defined as an half mirror placed in front of said display screen.
